(19) United States
(12) Patent Application Publication
(10) Pub. No.: US 2025/0227784 A1
(43) Pub. Date: Jul. 10, 2025

(54) POWER EFFICIENT AND ROBUST WAKE UP SIGNALING - RELAY MIGRATION

(71) Applicant: Telefonaktiebolaget LM Ericsson (publ), Stockholm (SE)

(72) Inventors: Bipin Balakrishnan, Kävlinge (SE); Gang Zou, Lund (SE); Saeed Bastani, Dalby (SE); Fredrik Dahlgren, Lund (SE)

(21) Appl. No.: 18/849,518

(22) PCT Filed: Mar. 23, 2022
(86) PCT No.: PCT/EP2022/057681

§ 371 Date: Sep. 22, 2024

(51) Int. Cl. H04W 76/14; H04W 48/20; H04W 88/04

(52) U.S. Cl. CPC H04W 76/14; H04W 48/20; H04W 88/04

(57) ABSTRACT

Systems and methods are disclosed for relay migration. In one embodiment, a method of operation of a network node for handover of one or more remote User Equipments (UEs) from a source relay UE to a target relay UE comprises determining that a triggering condition for handover of one or more remote UEs from a source relay UE to a target relay UE has occurred. The method further comprises, responsive to determining that the triggering condition has occurred, selecting one of a number of candidate target relay UEs as the target relay UE for the handover and causing handover and migration of state information to the target relay UE, the state information comprising state information of the one or more remote UEs.

### TECHNICAL FIELD

Systems and methods are disclosed herein that relate to relay migration in the context of relayed wake-up signaling.

### BACKGROUND

Relay-connections using sidelink or Device-to-Device (D2D) communication has been presented in order to increase the wireless communication coverage in situations where the Radio Frequency (RF) link between a Base Station (BS) and a User Equipment (UE) may be very poor or totally lost. For example, see Third Generation Partnership Project (3GPP) Long Term Evolution (LTE) D2D Proximity Services (ProSe) and an associated study in 3GPP Technical Report (TR) 36.843 entitled “Study on LTE Device to Device Proximity Services—Radio Aspects.”

On the other hand, wake-up signaling has been proposed to enable UEs to go into deep sleep and the BS to wake up the UEs with certain signaling. For example, the 3GPP LTE cellular network uses a Wake-Up Signal (WUS) to wake up Internet-of-Things (IoT) UEs. This WUS is transmitted from a BS to IoT UEs that are in idle mode (e.g., deep sleep) and required to decode the Physical Downlink Control Channel (PDCCH) in paging occasions (see, e.g., 3GPP Technical Specification (TS) 36.211 V16.1.0). In those cases, an IoT UE needs wake up to perform time and frequency synchronization, receive and decode the WUS, and further receive and decode the paging information carried in a PDCCH if the IoT finds the WUS is targeting itself. As the distance between the BS and the IoT UE is generally long, the WUS is often transmitted with a certain RF bandwidth and/or encoded in time or frequency domain to lower its miss-detection rate.

Ultra-low-power UEs (e.g., IoT UEs) may be powered from a battery with very limited capacity or from energy harvested from the environment in which the UEs are located. It is important that the amount of energy consumed by these UEs for communication is kept as low as possible. Allowing these UEs to go into a deep-sleep mode (e.g., idle mode) when there is no need to communicate is one technique for minimizing energy consumption. Another technique is to minimize the amount of energy consumed while the UE is performing necessary communication such as by keeping the UE's transmit power (e.g., Uplink (UL) transmit power) as low as possible.

There are many relevant usages of ultra-low-power UEs as different types of sensors, etc. They can be deployed in an environment in which the UEs have very poor RF links to the BSs, such as in basements, behind walls, etc. This can make it very challenging to guarantee that the UE is woken up properly by the BS and also require that the UL signaling from the UE at the wake-up must occur at a very high output power. Furthermore, wake-up mechanisms for such ultra-low power UEs should be robust and reliable against misdetection without consuming too much additional power.

Therefore, there is a need for systems and methods providing an energy efficient yet robust solution to wake up UEs, such as ultra-low power UEs, and transfer data between those UEs and the BS.

### SUMMARY

Systems and methods are disclosed for relay migration. In one embodiment, a method of operation of a network node for handover of one or more remote User Equipments (UEs) from a source relay UE to a target relay UE comprises determining that a triggering condition for handover of one or more remote UEs from a source relay UE to a target relay UE has occurred. The method further comprises, responsive to determining that the triggering condition has occurred, selecting one of a number of candidate target relay UEs as the target relay UE for the handover and causing handover and migration of state information to the target relay UE, the state information comprising state information of the one or more remote UEs. In this manner, increased robustness is provided as the system would tolerate that some relay UEs migrate away from their ability to operate as a relay UE, or that the radio channel condition changes making certain relay UEs less reliable.

In one embodiment, the one or more remote UEs are in idle state.

In one embodiment, the target relay UE is assigned a same relay identity (ID) as the source relay UE.

In one embodiment, causing handover and migration of state information to the target relay UE comprises sending, to the source relay UE, an indication to start handover and migration of state information to the target relay UE, the state information comprising state information of the one or more remote UEs. In one embodiment, the method further comprises sending a relay ID to the target relay UE, wherein the relay ID sent to the target relay UE is the same as a relay ID of the source relay UE.

In one embodiment, causing handover and migration of state information to the target relay UE comprises sending, to the target relay UE, information that indicates handover of the one or more remote UEs to the target relay UE and the state information of the one or more remote UEs.

In one embodiment, determining that the triggering condition for handover of the one or more remote UEs from the source relay UE to the target relay UE has occurred comprises detecting, by the network node, that the triggering condition has occurred. In another embodiment, determining that the triggering condition for handover of the one or more remote UEs from the source relay UE to the target relay UE has occurred comprises receiving, from the source relay UE, an indication that the triggering condition has occurred.

In one embodiment, the triggering condition for handover of the one or more remote UEs from the source relay UE to the target relay UE comprises the source relay UE becoming unresponsive, the source relay UE being unresponsive for a predefined amount of time, loss of connection between the source relay UE and at least one of the one or more remote UEs, loss of connection between the source relay UE and the one or more remote UEs, or a change in one or more conditions at the source relay UE that are related to operation of the source relay UE as a relay UE. In one embodiment, the one or more conditions comprise location of the source relay UE, mobility of the source relay UE, battery status of the source relay UE, change in workload of the source relay UE, change in battery supply of the source relay UE, or any combination thereof.

In one embodiment, the method further comprises receiving, from the target relay UE, a notification that an error has occurred during the handover and performing one or more actions to handle the error. In one embodiment, the error is a failure to setup connection to at least one of the one or more remote UEs. In one embodiment, performing the one or more actions comprises selecting a new target relay UE for at least one first remote UE from among the one or more remote UEs and initiating handover of the at least one first remote UE to the new target relay UE. In one embodiment, the at least one first remote UE is identified in the notification received from the target relay UE. In one embodiment, performing the one or more actions further comprises sending, to at least one second remote UE from among the one or more remote UEs, a notification related to the error.

In one embodiment, the network node is a base station. In another embodiment, the network node is a cluster head that operates as a proxy for a base station.

Corresponding embodiments of a network node are also disclosed. In one embodiment, a network node for handover of one or more remote UEs from a source relay UE to a target relay UE is adapted to determine that a triggering condition for handover of one or more remote UEs from a source relay UE to a target relay UE has occurred. The network node is further adapted to, responsive to determining that the triggering condition has occurred, select one of a number of candidate target relay UEs as the target relay UE for the handover and cause handover and migration of state information to the target relay UE, the state information comprising state information of the one or more remote UEs.

In one embodiment, a network node for handover of one or more remote UEs from a source relay UE to a target relay UE comprises processing circuitry configured to cause the network node to determine that a triggering condition for handover of one or more remote UEs from a source relay UE to a target relay UE has occurred. The processing circuitry is further configured to cause the network node to, responsive to determining that the triggering condition has occurred, select one of a number of candidate target relay UEs as the target relay UE for the handover and cause handover and migration of state information to the target relay UE, the state information comprising state information of the one or more remote UEs.

Embodiments of a method of operation of a source relay UE are also disclosed. In one embodiment, a method of operation of a source relay UE for handover of one or more remote UEs from the source relay UE to a target relay UE comprises receiving, from a network node, an indication to start handover of one or more remote UEs from the source relay UE to a target relay UE and migration of state information to the target relay UE, the state information comprising state information of the one or more remote UEs. The method further comprises, responsive to receiving the indication to start handover and migration of the state information, transferring the state information to the target relay UE.

In one embodiment, the one or more remote UEs are in idle state.

In one embodiment, the target relay UE is assigned a same relay ID as the source relay UE.

In one embodiment, the method further comprises sending a relay ID to the target relay UE, wherein the relay ID sent to the target relay UE is the same as a relay ID of the source relay UE.

In one embodiment, the method further comprises, prior to receiving the indication to start handover and migration of the state information, detecting that a triggering condition for handover of the one or more remote UEs from the source relay UE to a target relay UE has occurred and sending, to the network node, an indication that the triggering condition has occurred. In one embodiment, the triggering condition for handover of the one or more remote UEs from the source relay UE to the target relay UE comprises loss of connection between the source relay UE and at least one of the one or more remote UEs, loss of connection between the source relay UE and the one or more remote UEs, or a change in one or more conditions at the source relay UE that are related to operation of the source relay UE as a relay UE.

In one embodiment, the method further comprises, responsive to receiving the indication to start handover and migration of the state information, sending, to the target relay UE, an indication to start the handover.

In one embodiment, the method further comprises pausing relay configuration updates during the handover. In one embodiment, the method further comprises resuming relay configuration updates once the handover has completed.

In one embodiment, the method further comprises, once the handover is complete, receiving an indication to remove one or more configurations related to being a relay UE for the one or more remote UEs.

Corresponding embodiments of a source relay UE are also disclosed. In one embodiment, a source relay UE for handover of one or more remote UEs from the source relay UE to a target relay UE is adapted to receive, from a network node, an indication to start handover of one or more remote UEs from the source relay UE to a target relay UE and migration of state information to the target relay UE, the state information comprising state information of the one or more remote UEs. The source relay UE is further adapted to, responsive to receiving the indication to start handover and migration of the state information, transfer the state information to the target relay UE.

In one embodiment, a source relay UE for handover of one or more remote UEs from the source relay UE to a target relay UE comprises one or more transmitters, one or more receivers, and processing circuitry associated with the one or more transmitters and the one or more receivers. The processing circuitry is configured to cause the source relay UE to receive, from a network node, an indication to start handover of one or more remote UEs from the source relay UE to a target relay UE and migration of state information to the target relay UE, the state information comprising state information of the one or more remote UEs. The processing circuitry is further configured to cause the source relay UE to, responsive to receiving the indication to start handover and migration of the state information, transfer the state information to the target relay UE.

Embodiments of a method of operation of a target relay UE are also disclosed. In one embodiment, a method of operation of a target relay UE for handover of one or more remote UEs from a source relay UE to the target relay UE comprises receiving a relay ID in association with a handover of one or more remote UEs, the handover being from a source relay UE to the target relay UE and the relay ID being the same as a relay ID of the source relay UE. The method further comprises receiving state information in association with the handover of the one or more remote UEs from the source relay UE to the target relay UE, the state information comprising state information for the one or more remote UEs.

In one embodiment, the one or more remote UEs are in idle state.

In one embodiment, the method further comprises receiving, from the source relay UE, an indication to start the handover.

In one embodiment, the method further comprises pausing relay configuration updates during the handover. In one embodiment, the method further comprises resuming relay configuration updates once the handover has completed.

In one embodiment, the method further comprises performing a procedure to check whether handover was successful. In one embodiment, performing the procedure to check whether handover was successful comprises sending wake-up signals to the one or more remote UEs, determining whether wake-up signal acknowledgments are received from the one or more remote UEs responsive to sending the wake-up signals, completing the handover if wake-up signal acknowledgments are received from the one or more remote UEs, and sending a notification of an error to a network node if a wake-up signal acknowledgments is not received from at least one of the one or more remote UEs.

Corresponding embodiments of a target relay UE are also disclosed. In one embodiment, a target relay UE for handover of one or more remote UEs from a source relay UE to the target relay UE is adapted to receive a relay ID in association with a handover of one or more remote UEs, the handover being from a source relay UE to the target relay UE and the relay ID being the same as a relay ID of the source relay UE. The target relay UE is further adapted to receive state information in association with the handover of the one or more remote UEs from the source relay UE to the target relay UE, the state information comprising state information for the one or more remote UEs.

In one embodiment, a target relay UE for handover of one or more remote UEs from a source relay UE to the target relay UE comprises one or more transmitters, one or more receivers, and processing circuitry associated with the one or more transmitters and the one or more receivers. The processing circuitry is configured to cause the target relay UE to receive a relay ID in association with a handover of one or more remote UEs, the handover being from a source relay UE to the target relay UE and the relay ID being the same as a relay ID of the source relay UE. The processing circuitry is further configured to cause the target relay UE to receive state information in association with the handover of the one or more remote UEs from the source relay UE to the target relay UE, the state information comprising state information for the one or more remote UEs.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a system in which embodiments of the present disclosure may be implemented;

FIG. 2 is a flow chart that illustrates the operation of a base station, a relay User Equipment (UE), and a remote UE for Low Power Wake-Up (LPWUS) signaling in accordance with one embodiment of the present disclosure;

FIGS. 3A, 3B, 4A, and 4B illustrate example subframes in which a synchronization signal and a LPWUS are transmitted in accordance with example embodiments of the present disclosure;

FIG. 5 illustrates the operation of a base station, a relay UE, and a remote UE in accordance with at least some of the embodiments described herein;

FIG. 6 illustrates a system in which relayed group wake-up signaling may be used in accordance with one example embodiment of the present disclosure;

FIG. 7 is a flow chart that illustrates the operation of a base station to perform a grouping procedure in accordance with one example embodiment of the present disclosure;

FIG. 8 illustrates the operation of a base station, a relay UE, and a group of remote UEs for relayed group wake-up in accordance with one example embodiment of the present disclosure;

FIG. 9 is a flow chart that illustrates steps 804 and 806 of FIG. 8 in more detail, in accordance with another example embodiment of the present disclosure;

FIG. 10 is a flow chart that illustrates steps 804 and 806 of FIG. 8 in more detail, in accordance with another example embodiment of the present disclosure;

FIG. 11 illustrates one example of a system in which hierarchical wake-up is provided in accordance with an embodiment of the present disclosure;

FIG. 12 illustrates one example of a system that provides relayed group wake-up with overlapping groups in accordance with an embodiment of the present disclosure;

FIG. 13 is a flow chart that illustrates the operation of a remote UE that is simultaneously in two or more groups in accordance with one embodiment of the present disclosure;

FIGS. 14A and 14B illustrate examples of a system providing relay UE migration, or handover, in accordance with embodiments of the present disclosure;

FIGS. 15A and 15B illustrate the operation of the system of FIGS. 14A and 14B for relay UE handover in accordance with one embodiment of the present disclosure;

FIG. 16 is a flow chart that illustrates the operation of the target relay UE to perform at least one aspect of the sanity check procedure of step 1516 of FIG. 15B in accordance with an embodiment of the present disclosure;

FIG. 17 is a flow chart that illustrates the operation of the base station to perform error handling in response to receiving a notification that a target relay UE is not able to operate as a relay UE for the remote UE(s) being handed over, in accordance with an embodiment of the present disclosure;

FIG. 18 illustrate the operation of the system of FIGS. 14A and 14B for relay UE handover in accordance with another embodiment of the present disclosure;

FIG. 19 is a schematic block diagram of a radio access node according to some embodiments of the present disclosure;

FIG. 20 is a schematic block diagram that illustrates a virtualized embodiment of the radio access node of FIG. 19 according to some embodiments of the present disclosure;

FIG. 21 is a schematic block diagram of the radio access node of FIG. 19 according to some other embodiments of the present disclosure;

FIG. 22 is a schematic block diagram of a UE according to some embodiments of the present disclosure;

FIG. 23 is a schematic block diagram of the UE of FIG. 22 according to some other embodiments of the present disclosure;

FIG. 24 illustrates a telecommunication network connected via an intermediate network to a host computer in accordance with some embodiments of the present disclosure;

FIG. 25 is a generalized block diagram of a host computer communicating via a base station with a UE over a partially wireless connection in accordance with some embodiments of the present disclosure;

FIG. 26 is a flowchart illustrating a method implemented in a communication system in accordance with one embodiment of the present disclosure;

FIG. 27 is a flowchart illustrating a method implemented in a communication system in accordance with one embodiment of the present disclosure;

FIG. 28 is a flowchart illustrating a method implemented in a communication system in accordance with one embodiment of the present disclosure; and

FIG. 29 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

User Equipment (UE): One type of communication device is a UE, which herein refers to any wireless communication device that has access to (i.e., is served by) a wireless network (e.g., a cellular network). Some examples of a wireless communication device include, but are not limited to: a 3GPP UE (i.e., a UE in a 3GPP network), a Machine Type Communication (MTC) device (also referred to herein as a MTC UE, and an Internet of Things (IoT) device (also referred to herein as an IoT UE). Such UEs may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The UE may be a portable, hand-held, computer-comprised, or vehicle-mounted mobile device, enabled to communicate voice and/or data via a wireless connection.

Relay UE: As used herein, a “relay UE” is a UE that, in addition to having communication to/from a RAN node (e.g., a base station), can also have communication to and from another UE, for example, via a D2D link or 3GPP sidelink. This other UE is referred to herein as a “remote UE”. Furthermore, a relay UE can receive and transmit data and control signals on behalf of the remote UE(s) to which it has a direct communication link. The relay UE is in proximity of one or more remote UEs.

Remote UE: As used herein, a “remote UE” is a UE that is capable of both D2D or 3GPP sidelink communication to the relay UE and direct communication to a base station. Typically, the remote UE is power constrained. The remote UE operates in a deep-sleep mode of operation (e.g., 3GPP idle mode) and can be woken up by a wake-up signal. Sometimes in the present disclosure, the term “sensor UE” or “sensor node” is used to denote a type of remote UE that is extremely power constrained.

Network Node: As used herein, a “network node” is any node that is either part of the RAN or the core network of a cellular communications network/system.

Low-Power Wake-Up Signal (LPWUS): As used herein, a “LPWUS” is a special paging signal that is transmitted from a relay UE to one or more remote UEs to inform the one or more remote UEs to wake-up from a deep-sleep state (e.g., a 3GPP idle mode). The LPWUS has one or more characteristics (e.g., narrow bandwidth and/or simplified modulation and coding scheme) that enable a power cost for detecting the LPWUS at a remote UE to be less than a power cost for detecting a conventional WUS from a base station at the remote UE. The one or more characteristics of the LPWUS enable detection at the remote UE via a low power receiver, e.g., an envelope detector, comparator, and time-domain correlator.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Various aspects of the present disclosure are described below under separate headings. While the embodiments described in each section may be used independently, embodiments described in different sections below may also be combined.

### I. Low-Power Wake-Up Signal (LPWUS) Via Relay UE

As discussed above, there is a need for systems and methods providing an energy efficient yet robust solution to wake up UEs, such as ultra-low power UEs, and transfer data between those UEs and the base station. For ultra-low-power IoT devices, e.g. wireless sensors, placing relay nodes is one approach to extend cellular network coverage over them. For instance, Cheng, X., Du, D Z., Wang, L. et al. Relay sensor placement in wireless sensor networks, Wireless Network 14, 347-355 (2008) https://doi.org/10.1007/s11276-006-0724-8 (hereinafter referred to as the “Cheng Article”) proposed a solution to place relay nodes in a wireless sensor network. All the wireless sensors can be connected to the relay nodes, which are more powerful and able to transfer data over long distance. Further, in United States Patent Application Publication No. 2020/0163017 A1 (hereinafter “the '017 application”), the use of a relay UE to transmit a wake-up signal (WUS) to a remote UE (e.g., an IoT UE) is proposed. However, besides the WUS itself, there is a need to re-establish time synchronization between the IoT UE and the network when the IoT UE wakes up from deep sleep, and this demands further signal transmission/reception. This re-establishment of time synchronization is not addressed in the '017 application.

Systems and methods are disclosed herein that address the aforementioned and/or other problems. Embodiments of the solution disclosed herein are based on relayed wake-up of a remote UE (e.g., an IoT UE such as, e.g., a sensor) via a relay UE and subsequent data transfer between the relay UE and remote UE. The rationale is that the distance between the relay UE (e.g., selected based on coverage) and the remote UE is much shorter than the distance between base station and the remote UE making such a system more robust and leading to lower power consumption in the remote UE.

By introducing a relay UE, embodiments of the solution disclosed herein enable ultra-low-power UEs to enter/exit deep sleep without having to communicate directly with the base station.

Whereas the basic idea of using a relay node to transmit a wake-up signal to an IoT UE is described in the '017 application, there are multiple aspects of the embodiments disclosed herein, which are potentially independent, that all support a much more energy efficient and robust system:
A first aspect relates to mechanisms and procedures for re-establishing time and frequency synchronization of the remote UEs after deep sleep by the support of the relay UE. In this regard, two time/frequency re-synchronization schemes (denoted herein as “TRS1” and “TRS2”) to achieve various synchronization accuracy by a remote UE with the support of the relay UE are disclosed herein.
A second aspect relates to co-design of time and frequency (time/frequency) synchronization signals and a Low-Power Wake-Up Signal (LPWUS) transmitted by a relay UE so that the remote UE can be more power efficient when performing time/frequency synchronization and LPWUS detection.
A third aspect relates to optimizations in the signaling between the relay UE and the remote UE that, because of much shorter distances, are able to minimize power consumption at the remote UE. These optimizations may include, e.g., optimizations to a time offset between the synchronization signal and the LPWUS, optimizations to a bandwidth of the LPWUS and/or the synchronization signal, optimizations related to the type of modulation and coding used for the LPWUS (e.g., can be dynamically adapted to be more/less robust based on the distance between the relay UE and the remote UE), optimizations related to transmit power, etc.

Embodiments of the solutions disclosed herein may enable better coverage for UEs that are in deep sleep (i.e., low power) mode, may enable lower uplink transmit power from remote UEs (e.g., IoT UEs) for wake-up sequences and communication, and/or may allow for a simpler and lower power wake-up receiver mode within remote UEs.

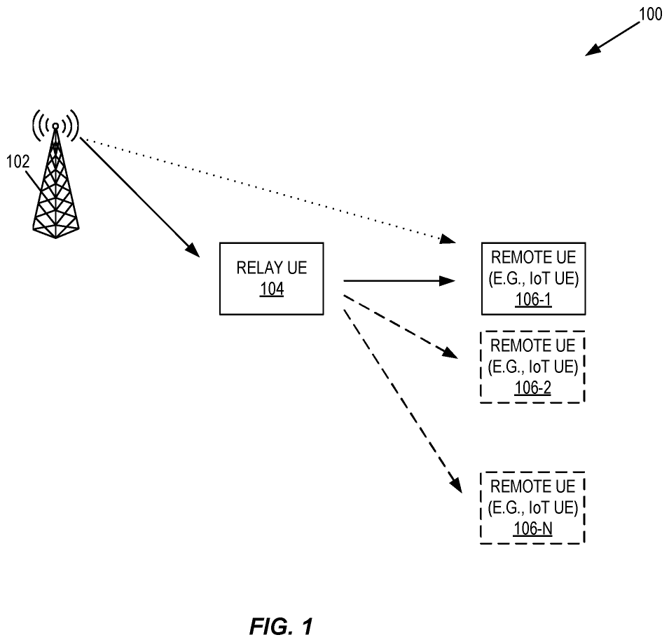

In this regard, FIG. 1 illustrates a system 100 in which embodiments of the present disclosure may be implemented. As illustrated, the system 100 includes a base station 102 and a relay UE 104 that operates as proxy between the base station 102 and one or more remote UEs 106-1 to 106-N, which are generally referred to herein collectively as remote UEs 106 and individually as a remote UE 106. The remote UEs 106 may be, for example ultra-low power IoT UEs. The remote UEs 106 operate in a deep sleep mode of operation (e.g., an idle mode) until woken up by a WUS or Low-Power WUS (LPWUS). In addition, the remote UEs 106 could be in a non-coverage region (i.e., they may have very poor Radio Frequency (RF) link to the base station 102 such that no or limited radio signal from the base station 102 can be received by the remote UEs 106 in the non-coverage region). A non-coverage region may also be referred to as a shadow region.

The base station 102 is aware, e.g., due to the authentication procedures, of remote UEs 106 in an area. The base station 102 can further identify a UE (or multiple UEs) in the vicinity of the remote UEs 106 as the relay UE 104 for these remote UEs 106. For example, the base station 102 may estimate the locations of the UEs under its coverage and select UEs close to the remote UEs 106 as relay candidates. Furthermore, based on received measurement reports from UEs, the base station 102 builds an understanding of coverage/signal strength, transmit power of UEs, mobility of the UEs, etc. and then determines both the remote UEs 106 and the relay UE 104 for those remote UEs 106. Thereafter, the base station 102 notifies both the relay UE 104 and the remote UEs 106 of the pairing. For example, the base station 102 may share UE IDs of the remote UEs 106 with the relay UE 104 and/or inform the remote UEs 106 of a relay ID of the relay UE 104. Once a pairing acknowledgement is received by the base station 102 from each individual remote UE 106 directly (or in some embodiments via the relay UE 104 on behalf of the individual remote UEs 106), the base station 102 notifies the remote UEs 106 directly (or in some embodiments via the relay UE 104), that they can go into a deep sleep mode and, upon reception of a wake-up signal, need to communicate with the relay UE 104 or communicate directly with the base station 102.

When the base station 102 desires to wake-up and fetch data from a remote UE 106 (or a group of remote UEs 106), the base station 102 transmits a WUS which includes identifier (ID) of that remote UE 106 (or that group of remote UEs 106). As described below in detail, the relay UE 104 operates to receive and decode the WUS on behalf of the remote UE 106 (or group of remote UEs 106). The relay UE 104 then generates and transmits a LPWUS so that the remote UE 106 (or group of remote UEs 106) for which the WUS from the base station 102 is intended is(are) woken-up. In one embodiment, the LPWUS is encoded with the ID of the remote UE 106 (or the ID of the group of remote UE(s)) to be woken-up.

As the distance between the relay UE 104 and the remote UEs 106 is much shorter than the distance between base station 102 and the remote UEs 106, the LPWUS transmitted from the relay UE 104 to the remote UEs 106 can be much simplified, as compared to the WUS transmitted by the base station 102, by using a simple radio waveform (for example, by being coded with On-Off Keying (OOK)) so that the power cost to detect the LPWUS by the remote UEs 106 can be much less than that to detect the WUS from the base station 102. For example, an Orthogonal Frequency Division Multiplexing (OFDM) transmitter can be used to generate the LPWUS as an OOK pulse. One example of a OOK wakeup signal and corresponding low-power receiver is described in J. Moody et al., “A −76 dBm 7.4 nW Wakeup Radio With Automatic Offset Compensation”, ISSCC 2018. Upon detecting the LPWUS, the remote UE 106 sends a LPWUS acknowledgement (ACK) only to the relay node 104 and not to the base station 102 which initiated the wake up signaling, which enables reducing the RF transmission power of the LPWUS ACK as compared to that which would be needed to transmit a WUS ACK to the base station 102.

In addition to the LPWUS, embodiments are disclosed herein to establish time and frequency re-synchronization for the remote UEs 106 in association with LPWUS detection. Embodiments disclosed herein optimize the time/frequency synchronization together with LPWUS detection for the sake of UE power saving.

Embodiments of the present disclosure consider one or more of the following aspects for the relay UE 104 to configure the synchronization signals together with the LPWUS:
waveform and bandwidth of the synchronization signals, e.g. OFDM multiple carrier signal or single carrier signal can be exploited as the synchronization signals,
coding scheme of the synchronization signals, e.g. the ID of the relay UE 104 can be encoded and carried by the synchronization signals,
time offset between the synchronization signal and the LPWUS, and
number of instances of synchronization signals.

Below are two example approaches for re-establishing time and frequency synchronization to achieve various levels of accuracy in the remote UE 106:
Time/Frequency Re-Synchronization scheme 1 (TRS1): The relay UE 104, which is time/frequency synchronized with the network (e.g., with the base station 102), transmits a synchronization signal followed by a LPWUS. The remote UE 106 detects the synchronization signal and performs time/frequency re-synchronization (e.g., with the relay UE 104) based on the detected synchronization signal. The synchronization signal may occupy a certain amount of frequency bandwidth and/or contain multiple instances so that the time/frequency synchronization in the remote UE 106 can achieve an accuracy level which enable the remote UE 106 to communicate directly with the base station 102 after waking-up upon detecting the LPWUS.
Time/Frequency Re-Synchronization scheme 2 (TRS2): The relay UE 104, which is time-synchronized with the network (e.g., with the base station 102), transmits a simpler synchronization signal (e.g., a single carrier synchronization signal) followed by a LPWUS. A relaxed time synchronization is established between the remote UE 106 and the relay UE 104 so that the remote UE 106 is able to communication directly with the relay UE 104 after waking up upon detecting the LPWUS. This scheme can lead to further optimizations when there is only a limited amount of data to be transferred.

To reduce the amount of power consumed by the remote UE 106 to perform time/frequency synchronization and LPWUS detection, a time offset between the synchronization signal and the LPWUS can be optimized so that the remote UE 106 can keep its active duration as short as possible while detecting both the synchronization signal and the LPWUS. Thus, in one embodiment, the LWPUS immediately follows the synchronization signal (i.e., the LPWUS starts in the OFDM that immediately follows an OFDM symbol in which the synchronization signal, or one of multiple instances of the synchronization signal, is transmitted).

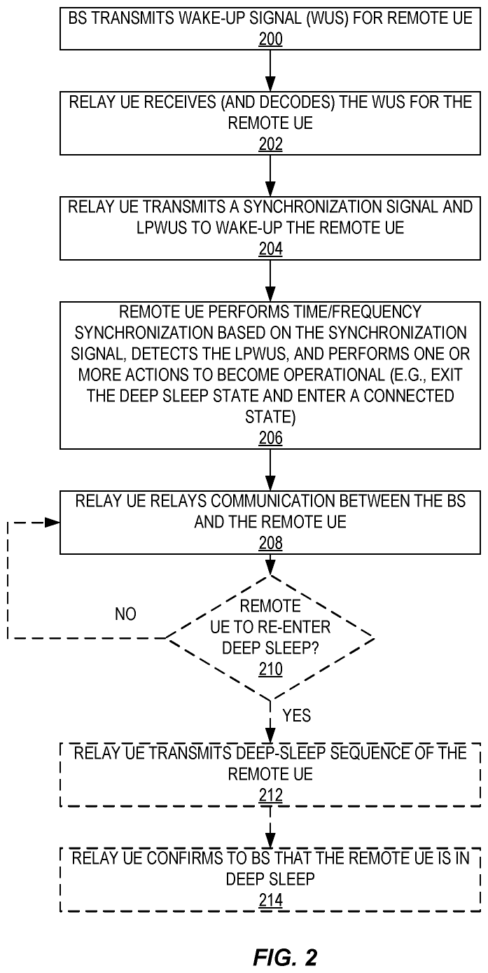

FIG. 2 is a flow chart that illustrates the operation of the base station 102, the relay UE 104, and the remote UE 106 in accordance with one embodiment of the present disclosure. Optional steps are denoted by dashed boxes/lines. As illustrated, in this embodiment, the base station 102 transmits a WUS containing the UE ID of the remote UE 106 (step 200). The relay UE 104 receives and decodes the WUS for the remote UE 106 (step 202). In other words, the relay UE 104 receives the WUS and decodes the WUS to determine that the WUS includes the UE ID of the remote UE 106. The relay UE 104 then generates and transmits a synchronization signal followed by a LPWUS to the remote UE 106 (step 204). More specifically, in one embodiment, the relay UE 104 transmits a synchronization signal. In addition, the relay UE 104 generates a LPWUS with a sequence based on the UE ID of the remote UE 106 and transmits the LPWUS following the synchronization signal. In one embodiment, the relay UE 104 transmits a single instance of the synchronization signal, and the LPWUS follows (e.g., immediately follows, e.g., in a next OFDM symbol) the single instance of the synchronization signal. In another embodiment, the relay UE 104 transmits multiple instances, or repetitions, of the synchronization signal, and the LPWUS follows (e.g., immediately follows, e.g., in a next OFDM symbol) one of the instances of the synchronization signal (e.g., immediately follows an k-th instance of the synchronization signal where N instances of the synchronization signal are transmitted and 1≤k≤N). Note that the LPWUS may be broadcast to all of the remote UEs 106 or may be unicast to the remote UE 106 for which it is intended via a respective D2D or 3GPP sidelink.

At the remote UE 106, the remote UE 106 performs time/frequency synchronization based on the synchronization signal and detects (e.g., receives and decodes) the LPWUS (step 206). In one embodiment, the LPWUS is encoded with the UE ID of the remote UE 106 and, as such, detection of the LPWUS includes determining that the UE ID with which the LPWUS is encoded matches the UE ID of the remote UE 106. In another embodiment, the LPWUS is encoded with a group ID of remote UEs 1106 (see details below regarding group WUS) and detection of the LPWUS includes determining that the group ID with which the LPWUS is encoded matches the group ID of the remote UE 106. Upon detecting the LPWUS (and determining that the encoded UE ID or group ID matches its own UE ID or group ID), the remote UE 106 performs one or more actions, e.g., to become operational (e.g., exists the deep-sleep mode and enters a connected mode) (step 206).

Once the remote UE 106 is operational, the remote UE 106 receives data from and/or transmits data to the relay UE 104 via a respective sidelink (step 208). Note that for uplink data transmission, once the relay UE 104 receives data from the remote UE 106, the relay UE 104 transmits the data to the base station 102. Likewise, for downlink data transmission, once the relay UE 104 receives data for the remote UE 106 from the base station 102, the relay UE 104 transmits the data to the remote UE 106 via the sidelink.

The relay node 104 may thereafter determine whether the remote UE 106 is to return to the deep-sleep mode (step 210). If so, in one embodiment, the relay UE 104 transmits a deep-sleep sequence of the remote UE 106 (step 212). The relay UE 104 may confirm to the base station 102 (e.g., upon receiving a deep-sleep ACK from the remote UE 106) that the remote UE 106 is in the deep-sleep state (step 214).

Now, some further description of aspects of the present disclosures related to time/frequency synchronization will be provided. In 3GPP LTE, a base station always broadcasts a Cell Reference Signal (CRS) which can be used by UE (e.g., a remote UE) to perform time/frequency synchronization. 3GPP NR does not specify this always-on broadcast signal from the NR base station (i.e., gNB), instead there are dedicated Synchronization Signal Blocks (SSBs) periodically broadcasted from a NR BS. By detecting SSB, a NR UE can perform time/frequency synchronization to the NR BS.

Assuming the relay UE 104 is always time/frequency synchronized with the network (e.g., with the base station 102), in one embodiment, a dedicated synchronization signal followed by the LPWUS may be transmitted/broadcast by the relay UE 104 (e.g., in step 204). By receiving the synchronization signal, the remote UE 106 (or a group of remote UEs 106) can perform frequency/time synchronization with the relay UE 104 so that it (or they) can correctly receive/decode the LPWUS following the synchronization signal.

Two example schemes for time/frequency re-synchronization, denoted herein as TRS1 and TRS2, are as follows.

TRS1: When the remote UE 106 is supposed to connect to the base station 102 after waking up, the relay UE 104 may configure its synchronization signal to the remote UE(s) 106 in the time and/or frequency domain and/or samples with better Signal to Noise Ratio (SNR) (e.g., via using more complex modulation and coding scheme). In one embodiment, in this case, the relay UE 104 may configure its synchronization signal to the remote UE(s) 106 with a more complex sequence occupying more RF resources in time and/or frequency domain (e.g. the synchronization signal transmitted by the relay UE 104 may be the sidelink synchronization signal specified in 3GPP LTE/NR) in order to guarantee high accuracy of time/frequency synchronization between the remote UE and the relay UE 104 and thus the base station 102. In other words, the amount of time and/or frequency domain resources occupied by the synchronization signal transmitted by the relay UE 104 (or the multiple instances of the synchronization signal transmitted by the relay UE 104) may be a function of whether the remote UE 106 is to communicate directly with the base station 102 after wake-up or is to communicate with the relay UE 104 (i.e., communicate with the base station 102 via the relay UE 104) after wake-up. For the former, more time and/or frequency resources are used in order to provide a sufficient level of time/frequency synchronization accuracy.

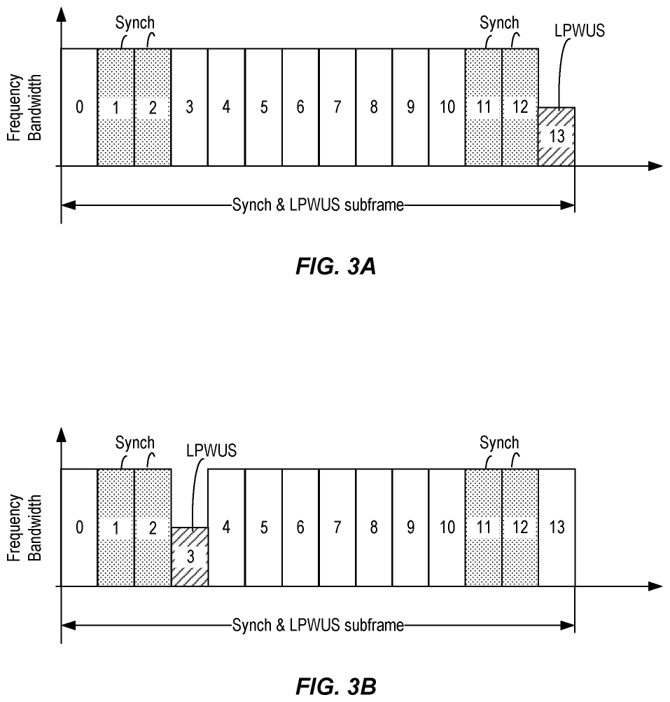

FIG. 3A shows an example of an LTE sidelink synchronization subframe including four synchronization symbols (symbols 1, 2, 11, and 12). In other words, the synchronization signal (or instances of the synchronization signal) is transmitted in symbols 1, 2, 11, and 12 in the example of FIG. 3A. These four synchronization symbols may be encoded by the ID of the relay UE 104. The subframe is transmitted by the relay UE 104. To wake up remote UEs 106 by the relay UE 104, in this example, symbol 13 is allocated for transmission of the LPWUS transmission (i.e., the LPWUS is transmitted in symbol 13 in this example). As shown in FIG. 3A, the four synchronization symbols may be allocated with higher bandwidth than the LPWUS. In other words, the synchronization signal may use a bandwidth that is greater than the bandwidth used for LPWUS.

Note that, in one alternative example, the LPWUS is transmitted in symbol 3 immediately following the second synchronization symbol (e.g., immediately following a second instance, or repetition, of the synchronization signal in symbol 2), as illustrated in FIG. 3B. This is to illustrate that, for example, the LPWUS need not necessarily follow the last instance of the synchronization signal (e.g., in a subframe), but may instead follow some prior instance of the synchronization signal (e.g., in the subframe). When the LPWUS is allocated between synchronization signals or between instances, or repetitions, of the synchronization signal (e.g., in symbol 3 as in FIG. 3B), the remote UE 106 may receive symbol 1 and 2 first, so that the remote UE 106 can be synchronized to the relay UE 104 and receive the following LPWUS. If the remote UE 106 finds the LPWUS is targeting the remote UE 106, it may then perform further time/frequency synchronization by receiving the synchronization signal instances, or repetitions, in additional symbols 11 and 12. Otherwise, it can skip the reception of the additional synchronization symbols.

To further optimize the power consumption of the remote UE 106, when the D2D SNR is high enough (e.g., above a predefined SNR threshold), the remote UE 106 may only receive a partial bandwidth of the synchronization signals. For example, the remote UE 106 may receive the synchronization signal (e.g., in symbols 1 and 2 of the examples of FIGS. 3A and 3B) with the same bandwidth as the LPWUS reception. The remote UE 106 can still be synchronized and receive the following LPWUS. If the remote UE 106 finds the LPWUS is targeting the remote UE 106, it may then further time/frequency synchronization by receiving the synchronization signal in symbols 11 and 12 with full bandwidth, and wakeup its main receiver. Otherwise, it can skip the reception of the additional synchronization symbols.

In one embodiment, the relay UE 104 may transmit additional synchronization signal(s) with a time offset to the LPWUS where the time offset is configured according to the duration of the wakeup process of the remote UE 106. When the remote UE 106 completes its wakeup process (which is triggered by the LPWUS), it can receive the synchronization signals and perform time/frequency synchronization. The remote UE 106 can receive the synchronization signal and perform time/frequency synchronization. As multiple symbols with high bandwidth can be used for the synchronization signal, high synchronization accuracy can be achieved between the remote UE 106 and the relay UE 104 (and also the base station 102). For example, after being woken-up by the LPWUS, the remote UE 106 can start a random access to set up radio connection with the base station 102.

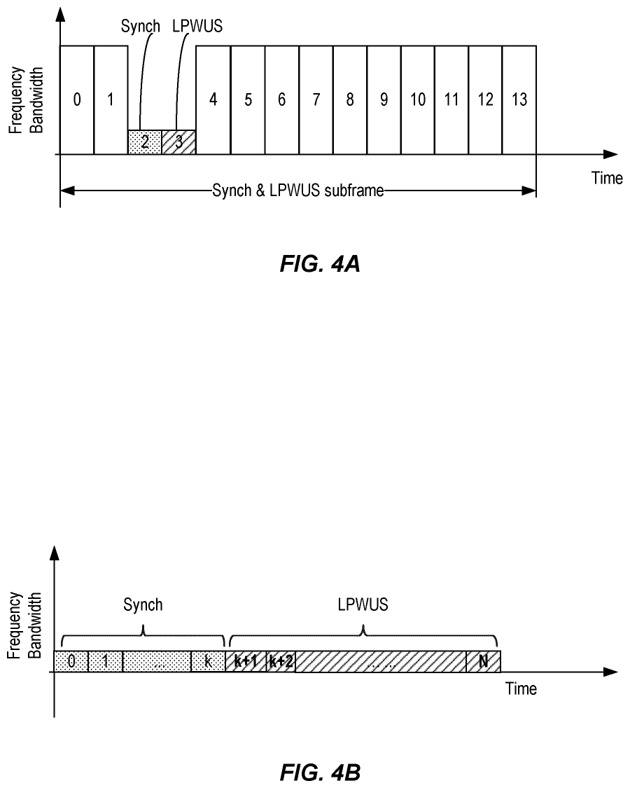

TRS2: When the remote UE 106 is not supposed to connect to the base station 102 after waking up, the relay UE 104 may configure its synchronization signal to the remote UE 106 with a simpler sequence occupying less RF resources in the time and/or frequency domain. As example is shown in FIG. 4A where the synchronization signal is transmitted is symbol 2 in a reduced bandwidth, and the LPWUS is transmitted in symbol 3 also in a reduced bandwidth. Using this simpler sequence, a relaxed time synchronization is established between the remote UE 106 and the relay UE 104 serving the needs for their sidelink communication. This scheme can be further optimized when there is only a limited amount of data to be transferred, and the relay UE 104 can act as a proxy for such data transfer and service requests. For example, when a simple modulation scheme (e.g., OOK) is applied to transfer small amount of data between the relay UE 104 and the remote UE 106, the sidelink can tolerate higher time/frequency synchronization errors (compared with TRS1) so the synchronization signal can be simplified, e.g., a single-tone signal can be used. Another example is illustrated in FIG. 4B. In this example, OOK modulation may be used where the synchronization signal and the LPWUS can be longer than 1 OFDM symbol.

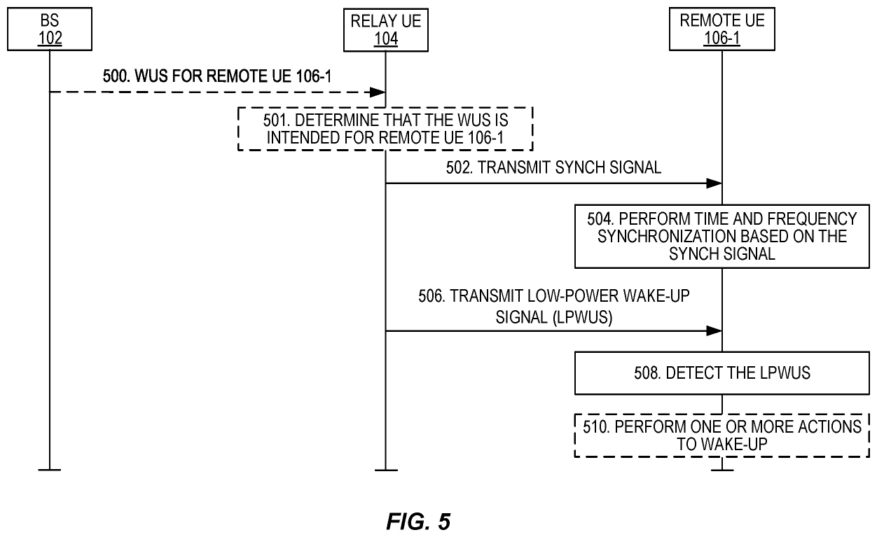

FIG. 5 illustrates the operation of the base station 102, the relay UE 104, and the remote UE 106-1 (in this example), in accordance with at least some of the embodiments described above. Optional steps are denoted with dashed lines/boxes. As illustrated, the base station 102 transmits a WUS that includes, is encoded with, or otherwise indicates the remote UE 106-1 (step 500). The relay UE 104 receives the WUS and determines that the WUS is intended for the remote UE 106-1 (step 501). The relay UE 104 transmits a synchronization signal (step 502). The remote UE 106-1 performs time/frequency synchronization based on the synchronization signal (step 504). The relay UE 104 also generates and transmits a LPWUS to the remote UE 106-1 (step 506). Note that the synchronization signal and the LPWUS may be in accordance with any of the embodiments described above. The relay UE 106-1 detects (i.e., receives and decodes) the LPWUS (step 508). Responsive to detecting the LPWUS, the remote UE 106-1 performs one or more actions to wake-up (step 510).

In one embodiment, the LPWUS has a bandwidth that is less than that of a WUS (e.g., the WUS of step 500) from the base station 102. In one embodiment, the LPWUS has a bandwidth that is less than 180 kilohertz (kHz). In one embodiment, the LPWUS is transmitted in at least one OFDM symbol. In one embodiment, the synchronization signal and the LPWUS are transmitted in a same subframe. In one embodiment, transmitting the synchronization signal in step 502 includes transmitting two or more instances, or repetitions, of the synchronization signal. The repetitions may be transmitted in the time domain and/or the frequency domain. In one embodiment, at least one repetitions of the synchronization signal is transmitted prior to the LPWUS. In one embodiment, all of the repetitions of the synchronization signal (e.g., in a subframe) are transmitted prior to the LPWUS (e.g., in the same subframe). In one embodiment, the two or more repetitions of the synchronization signal and the LPWUS are transmitted in a same subframe.

In one embodiment, a bandwidth of the synchronization signal is greater than a bandwidth of the LPWUS. In one embodiment, the bandwidth of the synchronization signal is less than or equal to a full receive bandwidth of the remote UE 106-1. In one embodiment, the remote UE 106-1 is an IoT UE. In one embodiment, the full receive bandwidth of the remote UE 106-1 is either 1.4 Megahertz (MHz) or 180 kHz.

In one embodiment, a single instance of the synchronization signal is transmitted. In one embodiment, this single instance of the synchronization signal is transmitted in at least one OFDM symbol that immediately precedes the LPWUS. In one embodiment, a bandwidth of the synchronization signal is less than a full receive bandwidth of the remote UE 106-1. In one embodiment, the remote UE 106-1 is an IoT UE. In one embodiment, the full receive bandwidth of the remote UE 106-1 is either 1.4 MHz or 180 kHz.

In one embodiment, a bandwidth of the synchronization signal is the same as a bandwidth of the LPWUS.

In one embodiment, at least one instance of the synchronization signal is transmitted in at least one OFDM symbol that immediately precedes an OFDM symbol in which the LPWUS is transmitted.

In one embodiment, either or both of a bandwidth of the synchronization signal and a bandwidth of the LPWUS is a function of one or more metrics related to one or more characteristics of a wireless channel between the relay UE 104 and the remote UE 106-1.

In one embodiment, either or both of a modulation or coding of the synchronization signal and a modulation or coding of the LPWUS is a function of one or more metrics related to one or more characteristics of a wireless channel between the relay UE 104 and the remote UE 106-1. In one embodiment, a transmit power used for transmitting the synchronization signal or the LPWUS is a function of the modulation or coding of the synchronization signal or the LPWUS, respectively.

In one embodiment, the LPWUS is encoded with an ID of the remote UE 106-1 or an ID of a group of remote UEs 106.

In one embodiment, the relay UE 104 unicasts the synchronization signal and/or the LPWUS to the remote UE 106-1. In another embodiment, the relay UE 104 broadcasts the synchronization signal and/or the LPWUS to multiple remote UEs 106 including the remote UE 106-1.

It should be noted that while the embodiments described herein focus on the LPWUS, the embodiments can be extended to additionally or alternatively apply to a Go-To-Sleep (GTS) signal which is transmitted by the base station 102 and a Low-Power GTS (LPGTS) signal transmitted from the relay UE 104 to the remote UE 106-1 to cause the remote UE 106-1 to enter the deep-sleep state.

### II. Relayed Group Wake-Up

Existing wake-up mechanisms, including both the WUS signaling mechanism defined in 3GPP LTE and WUS signaling mechanism via a relay UE as proposed in the '017 application, assume a one-to-one wake up signaling (from base station to a single device at a time). Arguably, these wake-up mechanisms are sub-optimal because they require numerous sequential wake-up processes (depending on the population of the IoT UEs) to run by the base station, resulting in increased delay and energy usage.

Systems and methods are disclosed herein that address the aforementioned and/or other problems associated with conventional wake-up mechanisms. More specifically, systems and methods are disclosed herein for relayed group wake-up (i.e., relayed wake-up signaling for a group of remote UEs (e.g., a group of IoT UEs)). Relayed group wake-up is more efficient in terms of delay and energy usage than existing wake-up mechanisms which rely on one-to-one wake-up signaling. Moreover, IoT UEs, due to their mission and service function types, could show very high similarity patterns in terms of geographic distribution, traffic type, and radio propagation status. Therefore, similar IoT UEs can be grouped, and wake up signaling can be performed in group-wise fashion so as to enhance the wake-up signaling efficiency.

Embodiments are disclosed herein for relayed group wake-up of a group of remote UEs (e.g., a group of IoT UEs such as, e.g., a group of sensors) and subsequent data transfer between a base station and the remote UEs via the relay UE. The rationale of relayed wake-up is that the distance between the relay UE and the remote UE (or group of remote UEs) is much shorter than the distance between base station and the remote UE (or group of remote UEs) making such a system more robust and leading to lower power consumption in the remote UE (or group of remote UEs). The rationale behind group wake-up is that remote UEs may bear similarities (e.g., in terms of service function types, traffic pattern, geographic distribution etc.) and, therefore, similar remote UEs can be grouped together and wake-up signaling can be performed in group-wise fashion. This enhances the efficiency of wake-up process in terms of latency and energy used for signaling without affecting the normal operation of individual remote UEs. Furthermore, the overhead for the base station is substantially lower since the relay UE manages the wake-up procedures via sidelink communication.

By introducing relay nodes and group wake-up mechanisms, the embodiments of the present disclosure enable ultra-low-power devices to enter/exit deep sleep without having to communicate directly with the base station, both during the relayed wake up signaling or re-synchronization signaling after the initial relayed wake-up signal.

Multiple aspects are described herein in relation to relayed group wake-up. These aspects may potentially be used independently from one another but may be used in combination. These aspects support a much more energy efficient and robust system enabled by relayed group wake-up. These aspects include:
1. Relayed group wake-up, where the relay UE is managing the wake-up, re-synchronization, and potential support for handling service requests, to a group of remote UEs.
2. Guidelines for grouping of remote UEs based on different similarity metrics.
3. Dynamic allocation of a group (or multiple groups) of remote UEs to a relay UE out of multiple candidate relay UEs.
4. Mechanisms and procedures for re-establishing time synchronization of the group of remote UEs after deep sleep.
5. Hierarchical wake-up, where an additional layer(s) of relay is introduced. This further increases the robustness and coverage of the system.
6. Overlapping wake-up groups.

Embodiments of the present disclosures related to relayed wake-up may provide one or more of the following advantages:
enable better coverage for devices that go in deep sleep,
enable lower uplink transmit power from remote UEs upon wake-up,
lead to more robust support for ultra-low-power devices entering deep-sleep via repeat wake up requests for selected wake up of unresponsive remote UEs,
allow for a simpler and lower power wake-up receiver mode within a WUS receiver that can also wake up based on a WUS from a base station.

Embodiments of the present disclosures related to group wake-up may provide one or more of the following advantages:
enhancement of the efficiency of wake-up procedure by minimizing the signaling overhead via simultaneous wake-up signaling to group of nodes,
differentiated wake-up solution through grouping of remote UEs and allocation of groups to different relay UEs,
reduced signaling overhead via (multicast) group re-synchronization instead of individual node by node fashion.

Embodiments of the present disclosures related to hierarchical wake-up may provide one or more of the following advantages:
ability to create an even more robust system with longer reach into areas not covered by the base station,
enable sequential wake-up where a remote UE in deep sleep, when it has been woken-up, can further manage of wake-up to additional units.

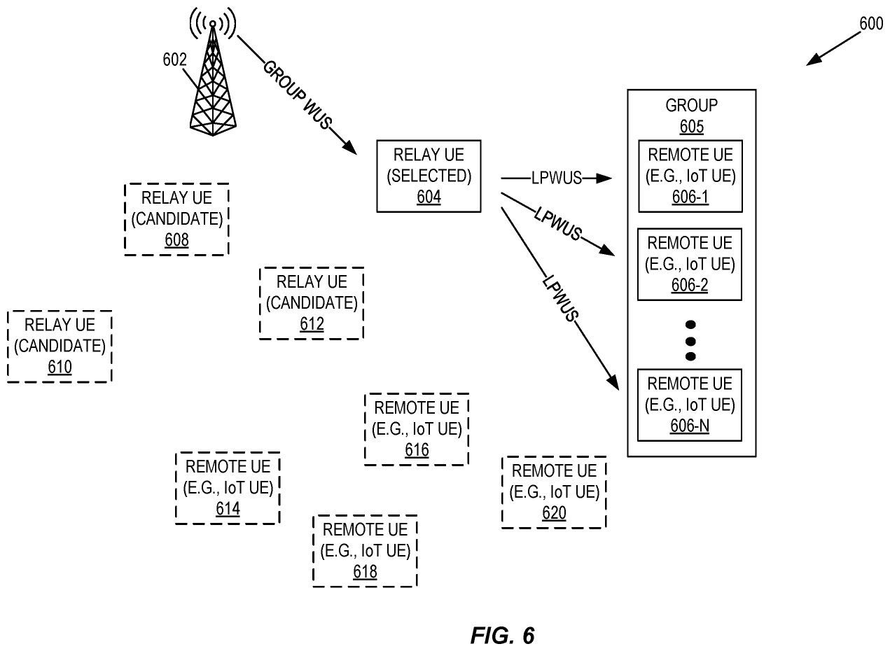

In this regard, FIG. 6 illustrates a system 600 in which relayed group wake-up signaling may be used in accordance with one example embodiment of the present disclosure. As illustrated, the system 600 includes a base station 602 and a relay UE 604 that operates to provide relayed group wake-up signaling for a group 605 of remote UEs 606-1 to 606-N, which are generally referred to herein collectively as remote UEs 606 and individually as remote UE 606. The relay UE 604 also acts as a proxy between the base station 602 and the remote UEs 606. The remote UEs 606 may be, for example ultra-low power IoT UEs. The remote UEs 606 operate in a deep sleep mode of operation (e.g., an idle mode) until woken up by a WUS. In addition, the remote UEs 606 could be in a non-coverage region (i.e., they may have very poor RF link to the base station 602 such that no or limited radio signal from the base station 602 can be received by the remote UEs 606 in the non-coverage region). A non-coverage region may also be referred to as a shadow region. In relayed group wake-up, the relay UE 604 is the link between the base station 602 and the remote UEs 606 in the group 605, where the remote UEs 606 may enter deep sleep mode and need to be activated by a wakeup signal. The relay UE 604 then manages, among other things, wake-up of the remote UEs 606.

The base station 602 is aware, e.g., as a result of authentication procedures, of remote UEs 606 and optionally remote UEs 614, 616, 618, and 620 in an area. The base station 602 can further identify a UE (or multiple UEs) in the vicinity as a candidate relay UEs(s) to these remote UEs 606, 614, 616, 618, and 620. For example, the base station 602 may estimate the locations of the UEs under its coverage and select UEs close to the remote UEs 606, 614, 616, 618, and 620 as candidate relay UEs. If a remote UE is introduced into the system 600 and has no immediate connection to the base station 602, this remote UE may search for potential relay UEs. This can be solved by, e.g., a conventional D2D peer discovery process. For example, the remote UE may periodically wake-up and listen for a reference signal (e.g., synchronization signal) from a relay UE. If it detects the reference signal and decodes the relay ID, it can setup a D2D, or sidelink, channel to the relay UE.

Furthermore, from measurement reports received by the base station 602, the base station 602 builds an understanding of the coverage/signal strength, UE transmit power, UE mobility, etc. and then, using this information, creates the group 605 of remote UEs 606 and selects the relay UE 604 for the group 605 of remote UEs 606. The base station 602 notifies both the relay UE 604 and the remote UEs 606 of the pairing. For example, the base station 602 may send the UE IDs of the remote UEs 606 to the relay UE 604 and/or inform the remote UEs 606 of the relay ID of the relay UE 604. Further, the base station 602 may send the group ID of the group 605 of remote UEs 606 to the relay UE 604 and, in some embodiments, the remote UEs 606 in the group 605. Once a pairing acknowledgement is received by the base station 602 from each of the remote UEs 606 directly (or in some embodiments via the relay UE 604 on behalf of the individual remote UEs 606), the base station 602 notifies the remote UEs 606 via the relay UE 604 that they can go into a deep sleep mode and, upon reception of a wake-up signal, should communicate with the relay UE 604, whose relay ID was shared during the pairing.

When the base station 602 desires to wake-up and fetch data from the group 605 of remote UEs 606, either by an explicit request from the base station 602 or because it is acting as a proxy for certain services and identifies the need to wake-up the group 605 of remote UEs 606, the relay UE 604 wakes-up the group 605 of remote UEs 606. The relay UE 604 checks if each of the remote UEs 606 in the group 605 is woken-up and establishes time synchronization. More specifically, in one embodiment, the base station 602 transmits a WUS which includes a group ID of the group 605 of remote UEs 606. This WUS is referred to herein as a “group WUS”. As described below in detail, the relay UE 604 operates to receive and decode the group WUS on behalf of the group 605 of remote UEs 606. The relay UE 104 then generates and transmits a WUS (e.g., a LPWUS such as that described in Section I above) to each of at least a subset of the group 605 of remote UEs 606 so that the remotes UE 606 in the group 605 for which the group WUS from the base station 602 is intended are woken-up. Note that, in one embodiment, the relay UE 604 sends a WUS (e.g., a LPWUS) to each remote UE 606 in the group 605. In another embodiment, the relay UE 604 first listens for ACKs, to the group WUS, from the remote UEs 606 in the group 605 and sends a WUS (e.g., a LPWUS) to only those remote UEs 606 in the group 605 for which it does not detect an ACK. In one embodiment, each LPWUS transmitted by the relay UE 604 is encoded with the UE ID of the respective remote UE 606. In addition, in one embodiment, the relay UE 604 supports the establishment of time re-synchronization for the remote UEs 606 (e.g., by transmitting both a synchronization signal and a LPWUS to each remote UE 606 as described above in Section I). Once the remote UEs 606 in the group 605 are woken-up, the relay UE 604 provides data transfer between the base station 602 and the remote UEs 606.

Note that a suitable candidate relay UE is a UE that is in an acceptable radio channel condition with respect to the base station 602. A suitable candidate relay UE should not have to go into deep sleep itself (although not mandatory) and it should support the signaling schemes to wake up other UEs. Furthermore, a suitable candidate relay UE should have good connection with the remote UEs 606 in the group 605 that are to enter deep sleep. The larger the number of remote UEs 606 with good coverage by a candidate relay UE, the better chance for the candidate relay UE to actually serve as relay UE, albeit bounded to a maximum number of remote UEs that can be handled by this relay UE. There are different criteria and approaches for how to appoint multiple remote UEs into a group for group wake-up, which are described below in detail.

In some embodiments, when remote UE 606 wakes up, it may perform a sanity-check to determine whether the paired relay UE 604 is responding to its requests. In some other embodiments, the remote UE 606 can skip this procedure and directly initiate communication with the relay UE 604 whose relay ID was obtained by the remote UE 606 before entering deep sleep.

It should be noted that there are several different group wake-up scenarios where additional mechanisms are proposed to further optimize for energy efficiency. These additional mechanisms may include any one or more of the following:
In one embodiment, the remote UEs 606 in the group 605 communicate with the base station 602 or network service, via the relay UE 604, and act upon requests, such as, e.g., probing for measuring data, to receive new settings, or whatever services will be requested over the communication channels. Each remote UE 606 has a dedicated communication channel to the base station 602 via the relay UE 604.
In one embodiment, the remote UEs 606 in the group 605 are treated by a network-based service(s) as one group. Individual group commands or data transfers are sent from the base station 602 to the relay UE 604, acting as a proxy to the group 605. Instead of relaying from the base station 602 to each remote UE 606 in the group 605 individually, the relay UE 604 multicasts the commands/transfers to all of the remote UEs 606 in the group 605. This is similar to multicast support but managed by the relay UE 604 and optionally also including acknowledgements from the remote UEs 606.
In one embodiment, the relay UE 604 acts fully as a proxy for service requests. The relay UE 604 pushes data to or polls data from the remote UEs 606 in the group 605 as they have been woken up and then commands them to go back to deep sleep.
In one embodiment, the grouping of the remote UEs 606 could be based on the similarity of UE roles, traffic patterns, and spatial/geographic distribution, and/or other criteria. The spatial/geographic distribution criterion could benefit a differentiated wake-up signaling for different groups with different spatial/geographic features, i.e. farther groups or shadowed groups will be signaled with more robust signaling or with higher transmit power by the relay UE 604. UE grouping based on geographic proximity could also serve better beamforming in the relay UE 604 in order to increase WUS robustness and/or minimizing interference with neighboring groups.
   a. Grouping of Remote UEs and Assigning Groups of Relay UEs

Establishment of groups can be performed in the appointment of relay UEs (e.g., the relay UE 604) such that a group wake-up request from the base station 602 to the relay UE (e.g., the relay UE 604) initiates the procedure of waking up the group of remote UEs (e.g., the group 605 of remote UEs 606). In another embodiment, the base station 602 can request the wake-up of a group by providing the identities of which remote UEs are to be woken up. In both these scenarios, the relay UE 604 is responsible for the complete wake-up sequences, including time re-synchronization, for all of the remote UEs 606 in the group 605. In one embodiment, if there are remote UEs 606 that do not wake-up, the relay UE 604 sends information about this to the base station 602, and the base station 602 then performs one or more actions to migrate those remote UEs 606 or the group 605 of remote UEs 606 to another relay UE.

In regard to grouping, remote UEs may bear natural similarities. Any one or more of the following criteria can be applied to a similarity measure for grouping (aka clustering) of the remote UEs with regards to certain degrees in the similarity measure:
Mission (i.e., service function performed by the IoT UE)
Traffic patterns
Geographic distribution
Experienced radio propagation quality (e.g., severe radio shadow).
   Note that the criteria above are only examples. Additional or alternative criteria may be used for grouping the remote UEs.

Each defined group of remote UEs is assigned to a relay UE. Note that a relay may be assigned at most one group of remote UEs. However, in another embodiment, a relay UE (e.g., the relay UE 604) may be assigned at most M groups of remote UEs, where M is greater than or equal to 1. The value of “M” may, e.g., be based on criterion such as, e.g., a defined maximum number of remote UEs in a group, the number of UEs in the group(s) assigned to the relay UE, one or more capabilities of the relay UE, information about expected traffic patterns for the group(s) of remote UEs assigned to the relay UE, or the like. A group(s) of remote UEs are assigned to a relay UE based on one or more of the following factors:
the number of available (candidate) relay UEs;
geographic distribution of (candidate) relay UEs, e.g., distance to each other, distance to the base station 602, distance to the center of each group of remote UEs, or the like;
capabilities of the (candidate) relay UEs, e.g., reliability, signaling support, battery power, compute power, etc.;
If the remote UEs serve different purposes, the grouping is done according to services so the ones having the same functions or that need to be activated at similar times are grouped together. Then, one relay UE might be defined to act as a proxy for a certain function, which then naturally is related to a certain group of remote UEs.

In principle, the grouping and assigning of remote UEs to relay UEs can be jointly solved for optimization. As there are several different possible reasons to form groups, it is not in the scope of the present disclosure to limit the embodiments described herein to one or a few of them.

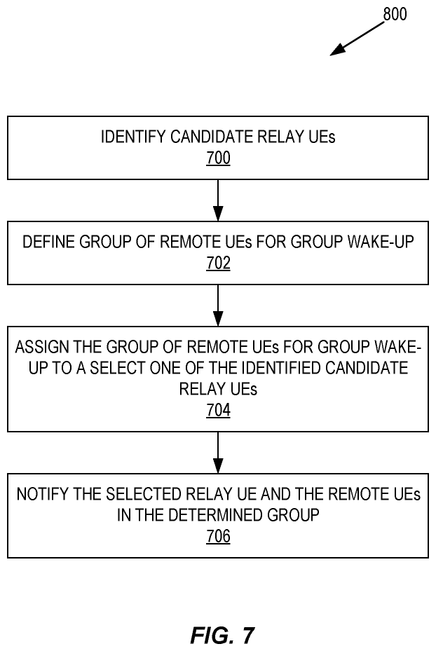

As illustrated in FIG. 7, in one embodiment, the grouping procedure contains the following steps:
Step 700: The base station 602 performs initial procedures to identify candidate relay UEs (e.g., candidate relay UEs 608, 610, 612, and the relay UE 604 which is ultimately selected for the group 605). The base station 602 could, for example, make use of the 3GPP Proximity Services functions for identification of the candidate relay UEs.
Step 702: Based on the system needs, the base station 602 defines groups of remote UEs, each to be served by a single relay UE. Groups can be defined based on, for example, service functions, geographic distribution of nodes, traffic patterns, frequency of wake-up, whether wake-up would be triggered by individual external events, and/or whether a relay UE will act as a service proxy for several remote UEs. As there are several different possible reasons to form groups, any desired criteria can be used for the grouping of remote UEs.
Step 704: The base station 602 appoints relay UEs to the defined groups of remote UEs (e.g., appoints the relay UE 604 to the group 605 of remote UEs 606 in the example of FIG. 6).
Step 706: The base station 602 notifies the relay UEs of the groups of remote UEs appointed to those relay UEs (including, e.g., the respective group IDs), and the relay UEs then confirm to the remote UEs in the respective groups.
   b. Group-Wake Up Solution and Signaling Mechanism(s)

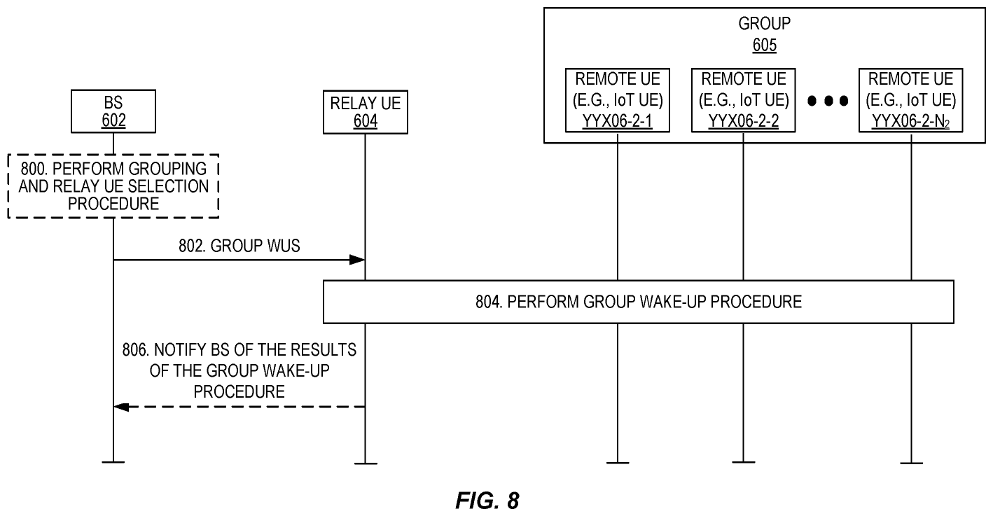

FIG. 8 illustrates the operation of the base station 602, the relay UE 604, and the group 605 of remote UEs 606 in accordance with one example embodiment of the present disclosure. Note that optional steps are represented by dashed lines/boxes. As illustrated, the base station 602 performs a procedure for grouping of remote UEs and relay UE selection for the defined groups, e.g., as described above with respect to FIG. 7 (step 800). Alternatively, the groups of remote UEs and the relay UEs to which the groups are assigned may be defined in another way, e.g., predefined and preconfigured by the appropriate configurations in the UEs. In this example, the group 605 of remote UEs 606 is defined and assigned to the relay UE 604.

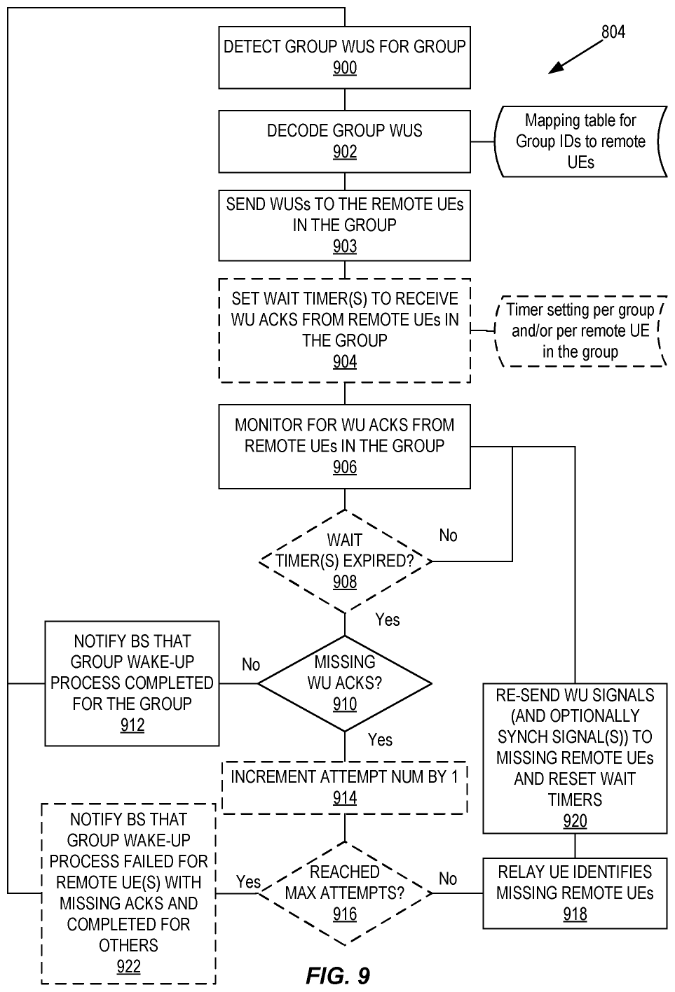

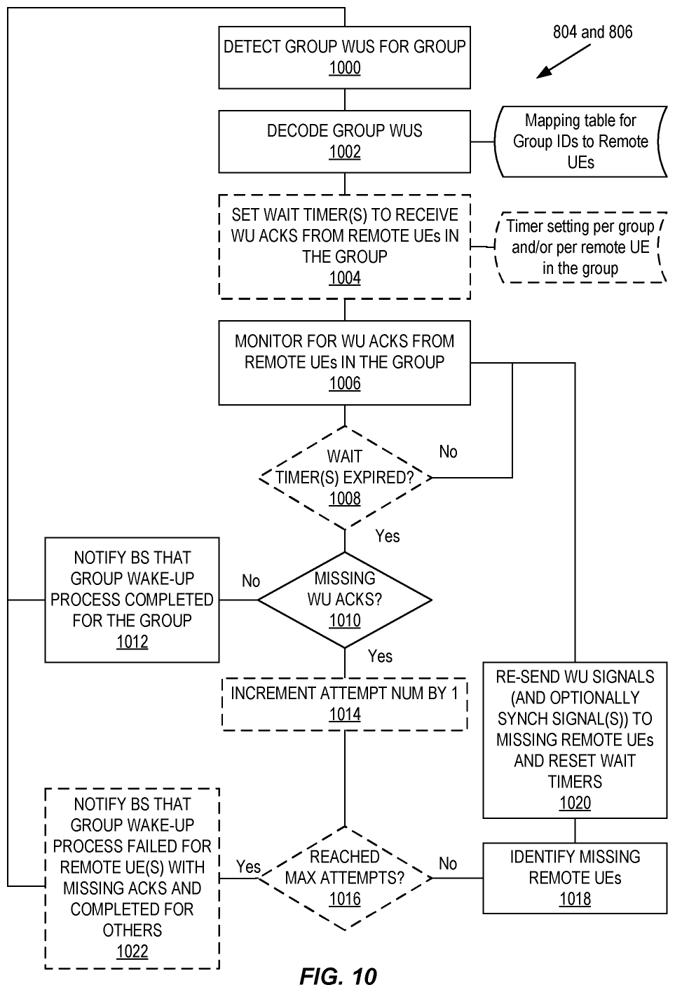

When wake-up of the group 605 of remote UEs 606 is desired, the base station 602 transmits a group WUS (step 802). The group WUS is encoded with or otherwise includes a group ID assigned to the group 605 of remote UEs 606. Upon detecting the group WUS for the group 605 of remote UEs 606, the relay UE 604 performs a group wake-up procedure whereby wake-up of the remote UEs 606 in the group 605 is performed (step 804). In one embodiment (see, e.g., FIG. 9), the relay UE 604 sends a separate WUS (e.g., a separate LPWUS) to each of the remote UEs 606 in the group 605 (or to the entire group at once) and, optionally, listens for WUS ACKs from the remote UEs 606. In another embodiment (see, e.g., FIG. 10 described below), the relay UE 604 first listens for group WUS ACKs from the remote UEs 606 in the group 605. The group WUS ACKs are sent by the remote UEs 606 upon detecting the group WUS from the base station 602 at the remote UEs 606. The relay UE 604 then transmits a separate WUS (e.g., a separate LPWUS) to each remote UE 606 in the group 605 for which the relay UE 604 did not detect a group WUS ACK.

The relay UE 604 then notifies the base station 602 of results of the group wake-up procedure (step 806). The results may include, for example, information that indicates the remote UEs 606, if any, there were not successfully woken-up. While not shown, the base station 602 may perform one or more actions based on the notification of step 806. For example, if all of the remote UEs 606 in the group 605 were successfully woken-up, the base station 602 may then proceed to send data or command(s) to the group 605 of remote UEs 606. As another example, if any of the remote UEs 606 in the group 605 were not successfully woken-up, the base station 602 may move those remote UEs 606 (i.e., the ones that were not successfully woken-up) or the group 605 of remote UEs 606 to a new relay UE.

FIG. 9 is a flow chart that illustrates steps 804 and 806 of FIG. 8 in more detail, in accordance with one example embodiment of the present disclosure. In other words, FIG. 9 is a flow chart that illustrates the operation of the relay UE 604 to perform a group wake-up procedure in accordance with one embodiment of the present disclosure. Optional steps are represented by dashed lines/boxes. As illustrated, the relay UE detects a group WUS for the group 605 of remote UEs 606 (step 900) and decodes the group WUS to obtain the group ID encoded in the group WUS (step 902). For example, the group WUS may be similar to a conventional WUS but encoded with the group ID of the group 605 of remote UEs 606.

In response to detecting the group WUS encoded with the group ID of the group 605 of remote UEs 606, the relay UE 604 generates and transmits a WUS (e.g., a LPWUS) to each of the remote UEs 606 in the group 605 (step 903). Note that IDs of the remote UEs 606 that are in the group 605 may be stored at the relay UE 606, e.g., in a look-up table based on the group ID. As described in section I above, in embodiments in which the relay UE 604 transmits a LPWUS to each of the remote UEs 606, the relay node 604 may transmit a synchronization signal in addition to the LPWUS to enable (re-)synchronization of the remote UEs to which the LWUS is transmitted. This is true for any of the embodiments described herein in which the relay UE 604 transmits a LPWUS to a remote UE 606.

The relay UE 604 then sets one or more timers to receive WUS ACKs from the remote UEs 606 in the group 605 (step 904). In one embodiment, a single timer is set for the group 605. In another embodiment, separate timers are set for the individual remote UEs 606 in the group 605, where different remote UEs 606 may have different timer values or the same timer value. While the timer(s) is(are) running, the relay UE 604 monitors for WUS ACKs from the remote UEs 606 in the group 605 (step 906).

Once the timer(s) has(have) expired (step 908, YES), the relay UE 604 determines whether any ACKs are missing (step 910). In other words, the relay UE 604 determines whether it has not detected a WUS ACK from any of the remote UEs 606 in the group 605. If none are missing (step 910, NO), the relay UE 604 notifies the base station 602 that wake-up of all of the remote UEs 606 in the group 605 is successful (step 912). If a WUS ACK was not detected for one or more of the remote UEs 606 in the group 605 (step 910, YES), the relay UE 604 increments an attempt count index (step 914) and determines whether a maximum number of wake-up attempts has been reached (step 916). The maximum number of attempts may be predefined or preconfigured and is an integer value greater than or equal to 1. Of course, the maximum number of wake-up attempts has an upper bound related to some defined or configured maximum acceptable amount of time that can be used for wake-up.

If the maximum number of wake-up attempts has not been reached (step 916, NO), the relay UE 604 identifies the remote UEs 606 in the group 605 for which WUS ACKs have not been received (step 918). The relay UE 604 re-sends a WUS signal (e.g., a LPWUS) to the identified remote UEs 606 and resets the timer(s) (step 920). Again, as described in section I above, in embodiments in which the relay UE 604 transmits a synchronization signal to each of the identified remote UEs 606, the relay node 604 may transmit a synchronization signal in addition to the LPWUS to enable (re-)synchronization of the remote UEs to which the LPWUS is transmitted. This is true for any of the embodiments described herein in which the relay UE 604 transmits a LPWUS to a remote UE 606.

After transmitting the WUS (e.g., LPWUS) to each of the identified remote UEs 606, the process then returns to step 906 where the relay UE 604 monitors for WUS ACKs from the remote UE(s) 606 to which the WUS was (re-)transmitted in step 920. This process continues until either WUS ACKs have been received from all of the remote UEs 606 in the group 605, in which case the relay node sends the notification in step 912, or until the maximum number of attempts has been reached. If the maximum number of attempts has been reached (step 916, YES), the relay UE 604 notifies the base station 602 that the group-wake up failed (step 922). This failure notification may include information that indicates the remote UE(s) 606 in the group 605 that have not been successfully woken up.

Note that if the relay UE 604 is assigned multiple groups of remote UEs, the relay UE 604 may perform the procedure of FIG. 9 sequentially for each group or for all of the groups in parallel.

FIG. 10 is a flow chart that illustrates steps 804 and 806 of FIG. 8 in more detail, in accordance with another example embodiment of the present disclosure. In other words, FIG. 10 is a flow chart that illustrates the operation of the relay UE 604 to perform a group wake-up procedure in accordance with one embodiment of the present disclosure. Optional steps are represented by dashed lines/boxes. As illustrated, the relay UE detects a group WUS for the group 605 of remote UEs 606 (step 1000) and decodes the group WUS to obtain the group ID encoded in the group WUS (step 1002). For example, the group WUS may be similar to a conventional WUS but encoded with the group ID of the group 605 of remote UEs 606. In response to detecting the group WUS encoded with the group ID of the group 605 of remote UEs 606, the relay UE 604 sets one or more timers to receive group WUS ACKs from the remote UEs 606 in the group 605 (step 1004). Note that the remote UEs 606 that are in the group may be stored at the relay UE 606, e.g., in a look-up table based on the group ID. In one embodiment, a single timer is set for the group 605. In another embodiment, separate timers are set for the individual remote UEs 606 in the group 605, where different remote UEs 606 may have different timer values or the same timer value. While the timer(s) is(are) running, the relay UE 604 monitors for group WUS ACKs from the remote UEs 606 in the group 605 (step 1006).

Once the timer(s) has(have) expired (step 1008, YES), the relay UE 604 determines whether any ACKs are missing (step 1010). In other words, the relay UE 604 determines whether it has not detected a group WUS ACK from any of the remote UEs 606 in the group 605. Note that, a remote UE 606, upon detecting the group WUS transmitted by the base station 602, transmits (e.g., broadcasts) a group WUS ACK including the UE ID of the remote UE 606. If none are missing (step 1010, NO), the relay UE 604 notifies the base station 602 that wake-up of all of the remote UEs 606 in the group 605 is successful (step 1012). If a group WUS ACK was not detected for one or more of the remote UEs 606 in the group 605 (step 1010, YES), the relay UE 604 increments an attempt count index (step 1014) and determines whether a maximum number of wake-up attempts has been reached (step 1016). The maximum number of attempts may be predefined or preconfigured and is an integer value greater than or equal to 1. Of course, the maximum number of wake-up attempts has an upper bound related to some defined or configured maximum acceptable amount of time that can be used for wake-up. In one embodiment, the maximum number of wake-up attempts is configured by the network (e.g., by the base station 602). In one embodiment, the maximum number of wake-up attempts is pre-configured before a group WUS is received. Any configuration changes after group WUS reception are carried out only for the next iteration of the group WUS. It should also be noted that the attempt number is reset upon decoding of the group WUS and before initial transmission of the LPWUS.

If the maximum number of wake-up attempts has not been reached (step 1016, NO), the relay UE 604 identifies the remote UEs 606 in the group 605 for which wake-up ACKs have not been received (either in response to the group WUS or some previous (LP)WUS attempt by the relay UE 604) (step 1018). The relay UE 604 (re-)sends a WUS signal (e.g., a LPWUS) to the identified remote UEs 606 and resets the timer(s) (step 1020). Note that the timer(s) may be reset to the same value(s) as used for monitoring upon detecting the group WUS or reset to a value(s) that is different than that used for monitoring upon detecting the group WUS. In one embodiment, for each iteration, a transmit power used by the relay UE 604 for resending the WUS is increased with respect to that used for the prior iteration. As described in section I above, in embodiments in which the relay UE 604 transmits a LPWUS to each of the identified remote UEs 606, the relay node 604 may transmit a synchronization signal in addition to the LPWUS to enable (re-)synchronization of the remote UEs to which the LWUS is transmitted. This is true for any of the embodiments described herein in which the relay UE 604 transmits a LPWUS to a remote UE 606.

After transmitting the WUS (e.g., LPWUS) to each of the identified remote UEs 606, the process then returns to step 1006 where the relay UE 604 monitors for WUS ACKs from the remote UE(s) 606 to which the WUS was (re-)transmitted in step 1020. This process continues until either wake-up ACKs have been received from all of the remote UEs 606 in the group 605, in which case the relay node sends the notification in step 1012, or until the maximum number of attempts has been reached. If the maximum number of attempts has been reached (step 1016, YES), the relay UE 604 notifies the base station 602 that the group-wake up failed (step 1022). This failure notification may include information that indicates the remote UE(s) 606 in the group 605 that have not been successfully woken up.

Note that if the relay UE 604 is assigned multiple groups of remote UEs, the relay UE 604 may perform the procedure of FIG. 10 sequentially for each group or for all of the groups in parallel.

c. Group Re-Synchronization

In one embodiment, in addition to sending the WUSs to the remote UEs 606 in the group 605, the relay UE 604 may transmit (e.g., unicast or broadcast) a set of time/frequency synchronization signals to the group 605 of remote UEs 606, e.g., via sidelink or D2D channel. By detecting the synchronization signals, the remote UEs 606 can perform time/frequency synchronization, e.g., to the relay UE 604. In one embodiment, the synchronization signals is encoded with the relay ID of the relay UE 604 so that the remote UEs 606 can also decode the group ID and understand which relay UE they are synchronized with. Furthermore, the synchronization signals and LPWUS can be bundled together and transmitted by the relay UE 604 (see, e.g., the description of the synchronization signal and LPWUS in Section I above).

d. Hierarchical Wake-Up

In one embodiment, hierarchical wake-up (i.e., hierarchical relayed wake-up) is provided. For hierarchical wake-up, at least one further level of relaying is introduced. This means that the relay UE that manages the wake up of a group of remote UEs (or an individual remote UE as in Section I above) does not connect directly to the base station. Instead, there is yet another relay node(s) in-between the relay UE and the base station. This concept is key to further increase the robustness and coverage of the system. There are different scenarios where this feature is beneficial:
In areas where certain remote UEs can be difficult to reach even with the appointed relay UE, one of the remote UEs that is not battery operated can be permanently or temporarily assigned as a second relay UE to secure a better wake-up coverage in that area.
Temporarily, a remote UE with good battery conditions can act as a wake-up relay for more distant remote UEs or remote UEs in especially poor RF conditions. That second relay UE can be either always on, meaning it does not enter deep-sleep itself, or it is allowed to enter deep-sleep but can support the more distant remote UEs as a relay after it has been woken up.

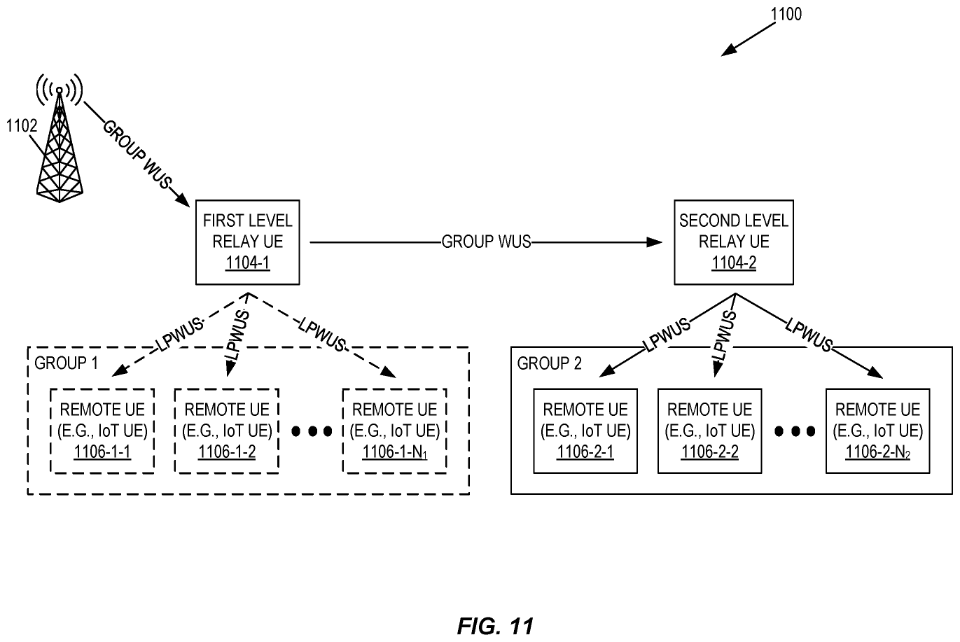

FIG. 11 illustrates one example of a system 1100 in which hierarchical wake-up is provided in accordance with an embodiment of the present disclosure. As illustrated, the system 1100 includes a base station 1102, a first relay UE 1104-1, and a second relay UE 1104-2. A group (Group 2) of remote UEs 1106-2-1 to 1106-2-N₂ (generally referred to herein collectively as remote UEs 1106-2 and individually as remote UE 1106-2) is assigned to the second relay UE 1104-2. Optionally, another group (Group 1) of remote UEs 1106-1-1 to 1106-1-N₁ (generally referred to herein collectively as remote UEs 1106-1 and individually as remote UE 1106-1) is assigned to the first relay UE 1104-1. In operation, when wake-up of Group 2 is desired, the base station 1102 transmits a group WUS encoded with a group ID of Group 2. The first relay UE 1104-1 relays the group WUS to the second relay UE 1104-2. The second relay UE 1104-2 detects the group WUS, decodes the group WUS to determine that it is intended for Group 2, and performs a group wake-up procedure for Group 2 as described above, e.g., with respect to FIG. 10 or FIG. 9.

In another embodiment, a larger group of remote UEs may be defined that includes both Group 1 and Group 2 shown in FIG. 11. In this case, a single group ID is assigned to this larger group. In other words, Group 1 and Group 2 shown in FIG. 11 have the same group ID. In this case, when wake-up of this larger group is desired, the base station 1102 transmits a group WUS that is encoded with the group ID of the larger group. The first relay UE 1104-1 relays the group WUS to the second relay UE 1104-2. In addition, the first relay UE 1104-1 decodes the group WUS and determines that the group ID matches that of the remote UEs 1106-1 in Group 1. The first relay UE 1104-1 then performs a group wake-up procedure for the remote UEs 1106-1 in Group 1 as described above, e.g., with respect to FIG. 10 or FIG. 9. The second relay UE 1104-2 detects the group WUS, decodes the group WUS to determine the group ID, determines that the group ID matches that of the remote UEs 1106-2 in Group 2, and performs a group wake-up procedure for Group 2 as described above, e.g., with respect to FIG. 10 or FIG. 9.

e. Overlapping Groups

In one embodiment, there may be overlapping groups of remote UEs for group wake-up. In this case, a remote UE(s) simultaneously belongs to two or more different groups. In an extreme case, there is a set of remote UEs where all of them belong to two groups, G_{A} and G_{B}, managed by two separate relay UEs, R_{A} and R_{B}. Note, however, that there are many different configurations and scenarios involving more than two groups and groups that are only partly overlapping. All such configurations and scenarios can be used.

One advantage of overlapping groups is that overlapping groups can be used to provide redundancy and hence robustness to the system. For example, if conditions are varying, the likelihood that a particular remote UE can be reached by one of the relay UEs increases if that remote UE belongs to two or more groups assigned to different relay UEs. Another benefit is that it is not as critical that a remote UE be migrated between to a new relay UE when that remote UE is not woken-up by a WUS from its relay UE. This is particularly beneficial if, in varying conditions, the remote UE would be migrated back and forth between the same two (or more) relay UEs. Using overlapping groups, this remote UE can belong to two (or more) groups assigned to the two (or more) relay UEs. Another advantage is that, when relay UEs act as proxies for certain types of services, they can connect to all remote UEs belonging to those services and, since a remote UE might support multiple different services or functions, the remote UE can belong to multiple different groups for the multiple different services or functions that it supports. Another advantage is that overlapping groups enable back-up of a relay UE. So, if for example R_{A} in above scenario by some reasons fail, there is already R_{B} supporting the same group that can be activated.

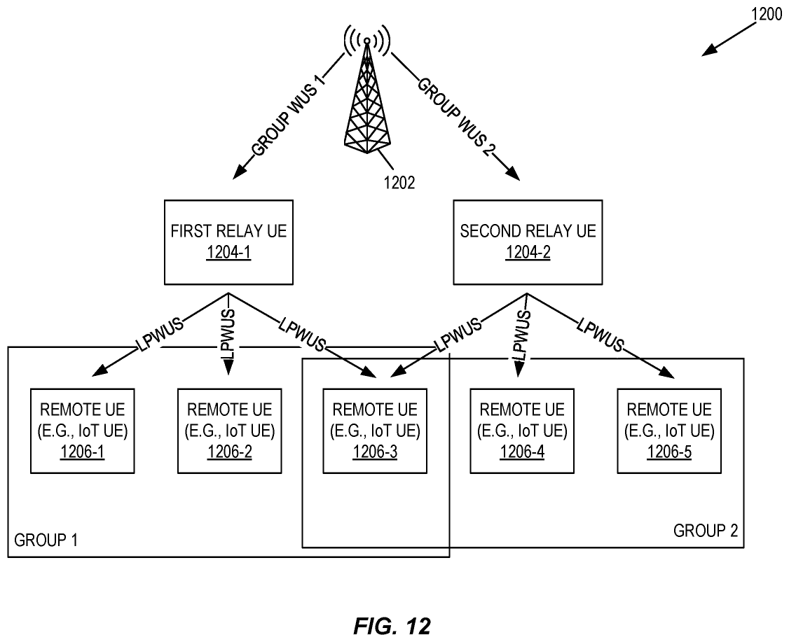

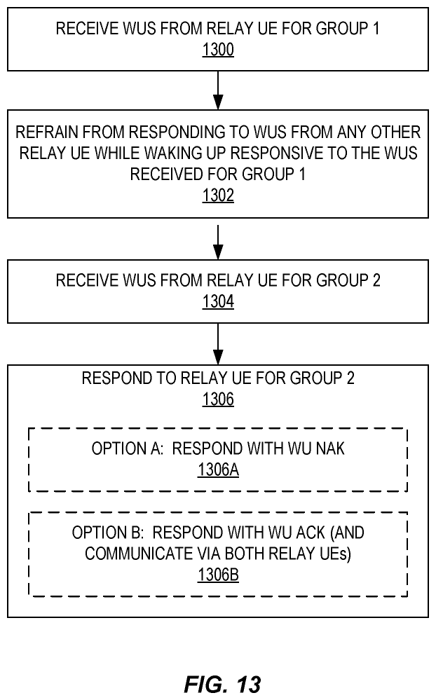

In this regard, FIG. 12 illustrates one example of a system 1200 that provides relayed group wake-up with overlapping groups in accordance with an embodiment of the present disclosure. As illustrated, the system 1200 includes a base station 1202, a first relay UE 1204-1, a first group (Group 1) of remote UEs 1206-1, 1206-2, and 1206-3 assigned to the first relay UE 1204-1, a second relay UE 1204-2, and a second group (Group 2) of remote UEs 1206-3, 1206-4, and 1206-5 assigned to the second relay UE 1204-2. Thus, in this example, Group 1 and Group 2 overlap and, specifically, the remote UE 1206-3 simultaneously belongs to both Group 1 and Group 2. Thus, the remote UE 1206-3 can, as part of group wake-up for Group 1, receive a WUS (e.g., a LPWUS) from the first relay UE 1204-1 and, as part of group wake-up for Group 2, receive a WUS (e.g., a LPWUS) from the second relay UE 1204-2.

Whereas overlapping groups provide robustness and flexibility, it comes with one key complication. Overlapping groups implies that, in some embodiments, a remote UE (e.g., the remote UE 1206-3 of FIG. 12) can receive WUSs from more than one relay UE. In this regard, FIG. 13 is a flow chart that illustrates the operation of a remote UE that is simultaneously in two or more groups in accordance with one embodiment of the present disclosure. Optional steps are represented by dashed lines/boxes. For this description, the remote UE 1206-3 of FIG. 12 is used as an example. As illustrated, the remote UE 1206-3 receives a WUS (e.g., a LPWUS) from the first relay UE 1204-1 (step 1300). After the remote UE 1206-3 has been activated based on the WUS from the first relay UE 1204-1, the remote UE 1206-3, during its initialization/re-synchronization phase, does not respond to other relay UEs (step 1302). In other words, the remote UE 1206-3 refrains from responding to other relay UEs while waking up in response to the WUS from the first relay UE 1204-1. In this example, sometime after waking up, the relay UE 1206-3 receives a WUS from the second relay UE 1204-2 for the second group (step 1304). The relay UE 1206-3 responds to the second relay UE 1204-2 (step 1306). In one embodiment, the response is a wake-up NAK (step 1306A). This wake-up NAK may indicate that the remote UE 1206-3 has already been woken-up by another relay UE.

In another embodiment, the remote UE 1206-3 responds to the second relay UE 1204-2 with a wake-up ACK and communicates via both the first relay UE 1204-1 and the second relay UE 1204-2 (step 1306B). This may be beneficial in a scenario where the different relay UEs 1204-1 and 1204-2 are managing different services. In this scenario, it might be relevant for the remote UE 1206-3 to respond to communication from both the first relay UE 1204-1 and the second relay UE 1204-2 while in active mode. This can be handled according to different approaches, which is decided at a system-level:
In one embodiment, only the first relay UE 1204-1 that woke up the remote UE 1206-3 acts as a proxy. Then, service requests from the second relay UE 1204-2 are communicated via the first relay UE 1204-1, potentially via the base station 1202. This is more complex from a system perspective but simplifies the scheme from the perspective of the remote UE 1206-3, and the re-synchronization at the remote UE 1206-3 need only be set for communicating via sidelink to the relay UE 1204-1. Go-to-sleep signaling can then come from one relay UE—the first relay UE 1204-1 that sent the first WUS.
In another embodiment, the remote UE 1206-3 can, after it is woken up, communicate via separate sidelinks with both the first relay UE 1204-1 and the second relay UE 1204-2. This scenario is simpler from an overall system perspective, as the relay UEs 1204-1 and 1204-2 can act independently to serve different needs. It adds some complexity on the remote UE 1206-3 as it needs to communicate via sidelink to two different relay UEs. In one embodiment, the remote UE 1206-3 does not re-enter deep sleep until receiving requests to do so from both the first relay UE 1204-1 and the second relay UE 1204-2.

### III. Relay Migration

In the '017 application, the use of a relay UE to transmit the wake-up signal to a remote UE (e.g., an IoT node) is proposed. However, besides the wake-up signal itself, there is a need to ensure that from deep sleep state, a remote UE can wake up to connect to the relay UE robustly. There would be situations wherein the serving relay UE could no longer be able to support the remote UE, e.g., due to failure of the relay UE or due to the relay UE becoming unsuitable to continue as a relay due to its own functionality. For example, the relay UE may move to another geographic location or may now only be able to support a smaller number of remote UEs or may become more suitable to act as a relay for another set of remote UEs. In such scenarios, it is easily possible to lose the state information about the remote UEs maintained at the relay UE, and the remote UEs will not have a relay UE to wake them up and communicate with after wake-up. This leads to losing the advantages of the efficient wake up and low power data transfer via the relay node as outlined in Section I above and also losing the advantage of relayed group wake-up as outlined in Section II above.

Embodiments are disclosed in this section that increase the robustness of the relayed wake-up mechanism of Section I above and/or the relayed group wake-up mechanism of Section II above so that there is always a relay UE to cater to a remote UE or a group of remote UEs while that remote UE or group of remote UEs is in deep sleep.

The embodiments disclosed in this section relate to various aspects including, but not limited to:
In a first aspect, the base station keeps monitoring the state of the relay UE. In case the base station finds that the relay UE enters a failure state or is otherwise unable or not preferred to operate as a relay for the associated remote UE(s), associated group(s) of remote UEs, or at least a subset thereof, the base station searches candidate relay UEs and selects one of the candidate relay UEs as a new relay UE for the remote UE(s) or group(s) of remote UEs or the at least a subset thereof.
   The base station migrates the states of the remote UEs maintained in the old relay UE to the new relay UE.
In a second aspect, the relay UE determines that it cannot support one or more of the remote UEs or group(s) of remote UEs (or a subset thereof) and then notifies the base station accordingly.
   This includes loss of connection due to the relay UE's own mobility or other reasons such as, e.g., workload, change in system configuration that remote UEs are being migrated to another location while in deep sleep.
   This also includes situations the scenario where the relay UE, for some reason, requests to enter deep sleep itself.
In a third aspect, a procedure for handing over a remote UE(s) or a group of UE(s) (or some subset of the remote UE(s) or group(s) of remote UEs assigned to the relay) to a new relay UE while the remote UE(s) is(are) still in deep sleep. During this procedure, state information (e.g. UE ID, group ID if the UE belongs to a group, UE capability, battery power level, hibernated functions, time synchronization method, mode of operation (e.g., TDD or FDD), information that indicates whether the UE provides concatenated readings and if so the number of messages (e.g., 2 to N where N is an integer number), etc.) of the remote UE(s) is(are) migrated from the old relay UE (referred to herein as the source relay UE) to the new relay UE (referred to herein as the target relay UE).

While not being limited by or to any particular advantage, the embodiments described herein related to migration of remote UE(s) or group(s) of remote UEs from one relay UE to another relay UE may provide a number of advantages. For example, these embodiments may provide increased robustness as the system would tolerate that some relay nodes migrate away from their ability to operate as a relay node, or that the radio channel condition changes making certain relay nodes less reliable. These embodiments enable this migration while the remote UE(s) is(are) still in deep sleep. These embodiments may make the overall system more robust and would be a more viable commercial solution, given the seamless support and remote orchestration.

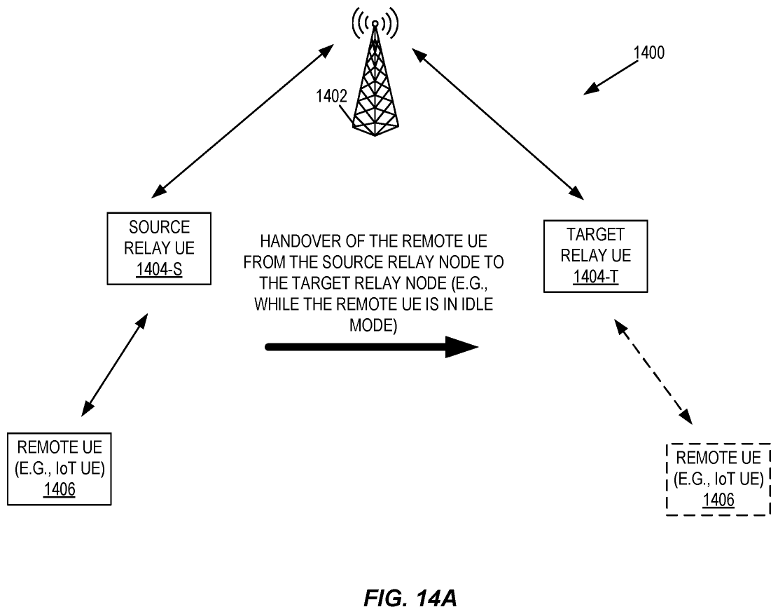

FIG. 14A illustrates one example of a system 1400 providing relay UE migration, or handover, in accordance with one embodiment of the present disclose. This embodiment may be used, for example, to provide relay UE migration in the context of the relayed wake-up mechanisms described above in Section I. Note, however, that the relay UE migration embodiments described herein are not limited to use in the context of relayed wake-up, but may be used in any type of relayed system where there is a benefit in migrating the states from one relay to another. As illustrated, the system 1400 includes a base station 1402, a relay UE 1404-S which is also referred to here as the source relay UE 1404 for purposes of the handover, a target relay UE 1404-T for the handover, and a remote UE 1406 that is initially assigned to the relay UE 1404 and then handed over to the target relay UE 1404-T while the remote UE 1406 remains in the deep sleep, or idle, state. In one embodiment, the base station 1400, the (source) relay UE 1404-S, and the remote UE 1406 correspond to the base station 102, the relay UE 104, and the remote UE 106 described above, where the (source) relay UE 1404-S operates to, among other things, provide relayed wake-up signaling to the remote UE 1406.

At some point, while the remote UE 1406 is in deep sleep, due to many factors (e.g., loss of connection due to source relay UE's own mobility or other reasons such as workload, change in system configuration, or low-battery condition that the remote UE 1406 is being migrated to another location while in deep sleep or situations where the source relay UE 1404-S for some reason requests to enter deep sleep itself), a decision is made to handover, or migrate, the remote UE 1406 from the source relay UE 1404-S to the target relay UE 1404-T. Details regarding how this decision is made are provided below. The remote UE 1406 is then handed over, or migrated, from the source relay UE 1404-S to the target relay UE 1404-T while the remote UE 1406 remains in the deep sleep, or idle, state. As described below in detail, this is done by sending state information for the remote UE 1406 and the relay ID of the source relay UE 1404-S to the target relay UE 1404-T.

FIG. 14B illustrates another example of a system 1400 providing relay UE migration, or handover, in accordance with one embodiment of the present disclosure. This embodiment builds upon the relayed group wake-up mechanisms described above in Section II. As illustrated, in this example, a group 1405 of remote UEs 1406 are assigned to the source relay UE 1404-S. In one embodiment, the base station 1400, the (source) relay UE 1404-S, and the group 1405 of remotes UE 1406 correspond to the base station 602, the relay UE 604, and the group 605 of remote UEs 606 described above in Section II, where the (source) relay UE 1404-S operates to, among other things, provide relayed group wake-up signaling to the group 1405 of remote UEs 1406.

At some point, while the remote UEs 1406 are in deep sleep, due to many factors (e.g., loss of connection due to source relay UE's own mobility or other reasons such as workload, change in system configuration that the remote UE 1406 is being migrated to another location while in deep sleep or situations where the source relay UE 1404-S for some reason requests to enter deep sleep itself), a decision is made to handover, or migrate, the group 1405 of remote UEs 1406 (or at least a subset of the remote UEs 1406 in the group 1405) from the source relay UE 1404-S to the target relay UE 1404-T. Details regarding how this decision is made are provided below. The group 1405 of remote UEs 1406 (or subset thereof) is then handed over, or migrated, from the source relay UE 1404-S to the target relay UE 1404-T while the remote UEs 1406 remain in the deep sleep, or idle, state. As described below in detail, this is done by sending state information for the group 1405 of remote UEs 1406 and the relay ID of the source relay UE 1404-S to the target relay UE 1404-T.

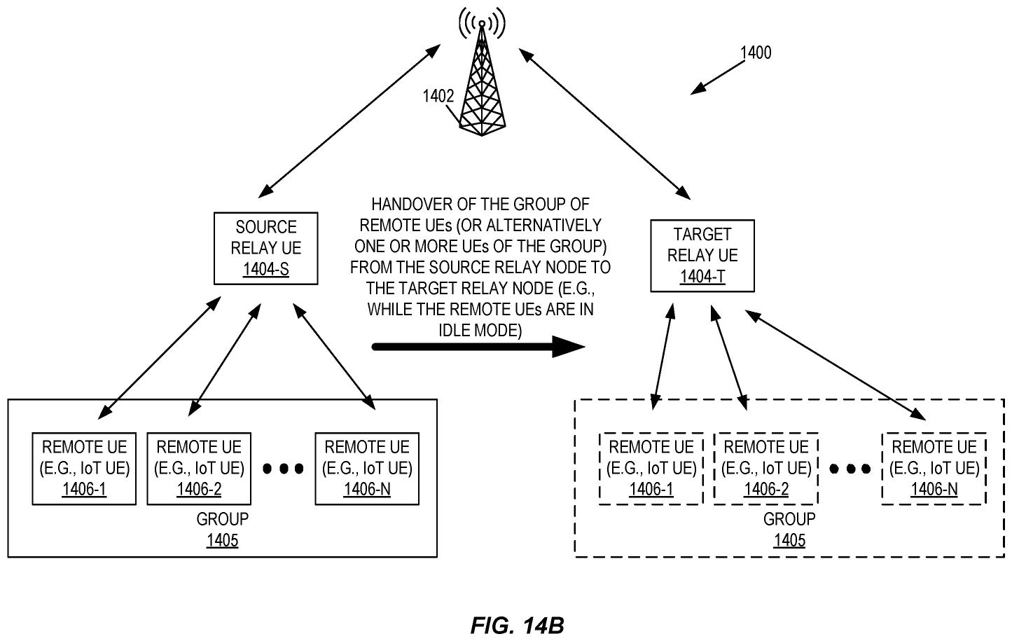

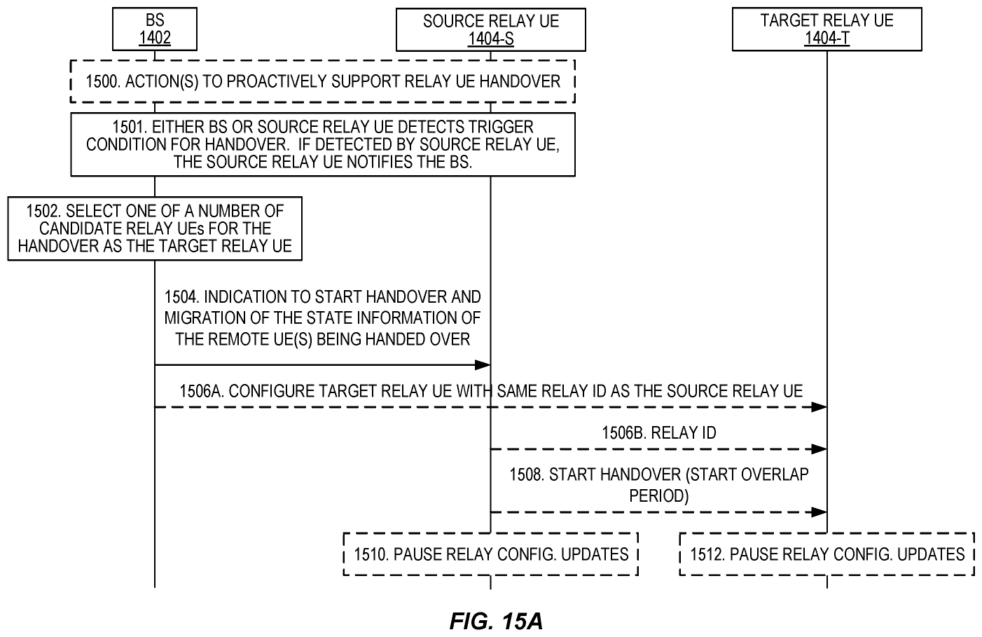

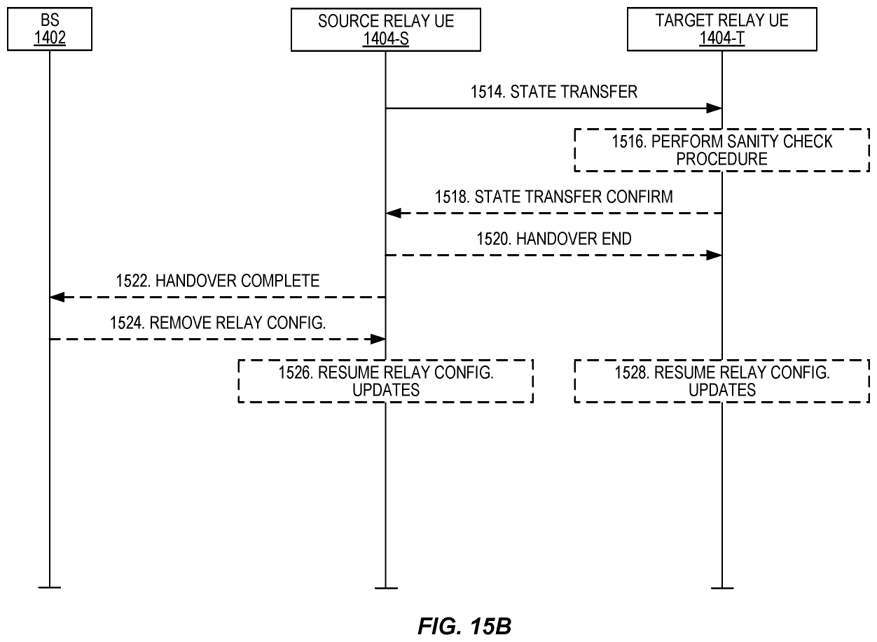

FIGS. 15A and 15B illustrate the operation of the system 1400 for relay UE handover in accordance with one embodiment of the present disclosure. Optional steps are represented by dashed lines/boxes. Further, the “steps” illustrated in FIGS. 15A and 15B are not necessarily performed in the illustrated order. These steps may be performed in any desired order unless otherwise indicated or required. As illustrated, one or more actions are performed to proactively support relay UE handover (step 1500). More specifically, to ensure that there is always a relay UE available and also for dynamic handover from one relay UE to another relay UE, the system 1400 proactively looks for candidate relay UEs. In the examples of FIGS. 14A and 14B, either the base station 1402 or the source relay UE 1404-S operate to identify candidate relay UEs for handover of the remote UE 1406 or the group 1405 of remote UEs 1406 from the source relay UE 1404-S. In one embodiment, the candidate relay UEs for the handover are identified by the base station 1402 or the source relay UE 1406 based on location of the remote UE(s) 1406 to be served, connection quality of the candidate relay UEs to the base station 1402, functions or applications running on the remote UE(s) 1406, or the like, or any combination thereof.

Note that, in one embodiment, not all remote UEs 1406 served by the source relay UE 1404-S will be migrated to the target relay UE 1404-T. Thus, in one embodiment, the candidate relay UEs may be based on new functions or applications that are being planned to be initiated in the future. There may be several reasons for this. Some candidate relay UEs might be in a good position for some of the remote UEs 1406 but bad for others, which might be a reason to have different candidate relay UEs for different subsets of the remote UEs 1406 served by the source relay UE 1404-S. Another might be because of the relative movements of the different (target, source, remote) UEs.

3GPP functions such as proximity services (ProSe) or equivalent functions are good candidate solutions for identifying location proximity and checking the connection quality between the base station 1402 and the candidate relay UEs. The problem that poor communication link quality to the remote UEs 1406 is mitigated partially by selection of candidate relay UEs that are in proximity to the source relay UE 1404-S and where possible also considering local environment information such as, e.g., line of sight, etc.

At some point, either the base station 1402 or the source relay UE 1404-S detects a triggering condition for handover of the remote UE 1406 or the group 1405 of remote UEs 1406 (or some subset thereof) (step 1501). If detected by the source relay UE 1404-S, the source relay UE 1404-S notifies the base station 1402. In the following, a few example triggering conditions are described. Note, however, that these example triggering conditions are only examples. Other triggering conditions may be used. A first example triggering condition is that the (source) relay UE 1404-S is unresponsive (e.g., to the base station 1402) for a predefined or preconfigured amount of time. To recover from scenarios wherein the (source) relay UE 1404-S becomes unresponsive, in one embodiment, a timer is utilized at the base station 1402 or specifically where the relay allocation application is residing. When the (source) relay UE 1404-S is unresponsive for an amount of time that is greater than or equal to the timer value, the base station 1402 (or relay allocation application residing at the base station 1402 or another network node) determines that the triggering condition for relay UE handover is satisfied.

A second example triggering condition is loss of connection between the (source) relay UE 1404-S and the remote UE(s) 1406. To support robust scenarios where the (source) relay UE 1404-S might lose connection to the remote UE(s) 1406 due to its mobility, loss of connection for triggering relay UE handover is to be distinguished from intermittent loss of connection and instead refers to a longer duration loss of connection. In one embodiment, the base station 1402 keeps track of the (source) relay UE 1404-S trajectory and pre-determines if it is going to enter a radio shadow region and, if so, for how long. Radio shadow prediction is known to those of ordinary skill in the art. Thus, the details for how this radio shadow prediction is done are not provided here. In alternative embodiments, the (source) relay UE 1404-S can notify the base station 1402 of changes in the position of the (source) relay UE 1404-S. The base station 1402 can determine or predict when there will be a loss of connection based on the location of the (source) relay UE 1404-S and, possibly, predicted future location(s) of the (source) relay UE 1404-S determined, e.g., based on the trajectory and possibly speed of movement of the (source) relay UE 1404-S. The base station 1402 may also consider the location(s), trajectory(ies), and/or predicted future location(s) of the remote UE(s), e.g., relative to that of the (source) relay UE 1404-S and/or known environmental impediments (e.g., buildings, etc.).

Now there are two sub-cases based on the duration of radio shadow, which could be programmable as it is very use-case dependent. If the transition through the radio shadow or loss of connectivity is short (e.g., duration is less than a predefined or preconfigured threshold duration), then the triggering condition for relay UE handover is not satisfied. Rather, in one embodiment, the (source) relay UE 1404-S is instructed (by the base station 602 ahead of time) to transmit a WUS (e.g., LPWUS) to the remote UE(s) 1406 or group 1405 of remote UEs 1406, particularly for those remote UE(s) 1406 for which the base station 1402 does not know the wake-up status. The remote UE(s) 1406 then respond with a signal like the WUS ACK or even a specific ACK signal corresponding to the wake-up status signal. Note that if such an intermittent loss of connection happens quite a lot, an optional step could be further added to the procedure to remove the (source) relay UE 1404-S from acting as a proxy and instead allow the base station 1402 and remote UE(s) 1406 to communicate directly.

If the transition through the radio shadow or loss of connection is longer (e.g., greater than a predefined or preconfigured threshold), then the triggering condition for relay UE handover is satisfied. In this case, the procedure for handover and relay migration to the target relay UE 1404-T described below is performed after the existing relay UE issues a wake-up abort indication to the remote UE(s) 1406. The wake-up abort indication is to indicate proactively to the remote UE(s) 1406 that, in case there is an ongoing wake up procedure, it is to be aborted as the source relay 1404-S would not be able to continue this ongoing wake-up procedure, e.g., as described in Section I above. In response to the wake-up abort indication, the remote UE(s) 1406 may choose to enter deep sleep or alternatively, if possible, directly connect with the base station 1402.

A third example triggering condition for relay UE handover is a change in one or more parameters related to the (source) relay UE 1404-S. If the (source) relay UE 1404-S determines that it no longer wants to support the remote UE 1406 or the group 1405 of remote UEs 1406 (or some subset thereof), e.g. due to its location or mobility, due to workload changes or changed power supply from plug-in power to battery, or the like, as a relay, the (source) relay UE 1404-S notifies the base station 1402 (or relay handover application at the base station 1402 or some other network node). Upon receiving this notification, the relay UE handover is performed, as described below.

Once the triggering condition for relay UE handover is satisfied, the base station 1402 (or relay allocation application residing at the base station 1402 or another network node) selects the target relay UE 1404-T (step 1502). In one embodiment, the target relay UE 1404-T is selected from the candidate relay UEs identified in step 1500. In one embodiment, the base station 1402 selects the target relay UE 1404-T based on the earlier preparations performed in step 1500 and selects the target relay UE 1404-T such that it has good radio characteristics to the base station 1402, the source relay UE 1404-S, and the remote UE(s) to be handed over. In one embodiment, the base station 1402 could also instruct the source relay UE 1404-S to adjust its position relative to the target relay UE 1404-T to enable efficient migration state information of the remote UE(s) 1406 being handed over. Importantly, the relay ID of the target relay UE 1404-T is made the same as that of the source relay UE 1404-S and it can be seen as a multi-cast ID as it is shared by at least two relay UEs. This simplifies things by allowing the remote UE(s) 1406 to communicate with the target relay UE 1404-T upon wake-up.

The selection of the target relay UE 1404-T differs from the normal procedure of appointing a relay UE in that the remote UE(s) 1406 being handed over is(are) now in deep sleep and thus not responsive. In one embodiment, when the number of participating entities is limited, this selection is done by first requesting the candidate relay UEs to transmit wake-up signals and then assessing responsive actions from the remote UE(s) 1406 being handed over. In another embodiment, the selection of the target relay UE 1404-T is done in parallel with triggering condition detection. For example, if the triggering condition is unresponsiveness of the source relay UE 1404-S for a duration of time defined by a timer, the selection of the target relay UE 1404-T may be performed after the timer value exceeds a threshold but has not yet reached the timeout value. In one embodiment, the selection of the target relay UE 1404-T is not completed until the selected relay UE indicates that it can wake up the remote UE(s) 1406 being handed over.

Note that the number of candidate target relay UEs may be one or more candidate target relay UEs. It could be well possible that there is only one candidate target relay UE. There could be a case where there is zero candidate target relay UEs available. In this case, the network node notifies the source relay UE 1404-S that no relay migration is possible, at least temporarily. Then, perhaps later on in time, when a new candidate target relay UE is added to the system or becomes available due to, for example, improved battery condition of an earlier unavailable relay UE, the relay migration procedure can be performed.

Once the target relay UE 1404-T is selected, the relay UE handover procedure is performed such that state information of the remote UE(s) being handed over, the group ID of the group 1405 if applicable, and the relay ID used by the source relay UE 1404-S are sent to the target relay UE 1404-T. In one word, the base station 1402 performs one or more actions to cause handover and migration of UE context information to the target relay UE 1404-T. More specifically, in the illustrated embodiment, the base station 1402 sends an instruction to the source relay UE 1404-S to start the handover and state migration with the target relay UE 1404-T (step 1504). This instruction includes the address or other information that enables the source relay UE 1404-S to communicate with the target relay UE 1404-T (e.g., via a D2D link or sidelink) for purposes of performing the handover. In one embodiment, the base station 1402 provides the relay ID to the target relay UE 1404-T (step 1506A). This relay ID is that same as the relay ID used by the source relay UE 1404-S. Alternatively, the source relay UE 1404-S sends its relay ID to the target relay UE 1404-T (step 1506B). This may be done directly, e.g., via a sidelink between the source relay UE 1404-S and the target relay UE 1404-T or may be done indirectly, e.g., via the base station 1402.

The source relay UE 1404-S sends an indication to the target relay UE 1404-T to start an overlap period during which both the source relay UE 1404-S and the target relay UE 1404-T are both active and share the same relay ID and during which state information is to be communicated from the source relay UE 1404-S to the target relay UE 1404-T (step 1508). The source relay UE 1404-S may send the indication to the target relay UE 1404-T directly, e.g., via a sidelink or indirectly, e.g., via the base station 1402. The overlap period may have a duration that is based on connection speed, whether there is line-of-sight (LOS) between the source relay UE 1404-S and the target relay UE 1404-T, etc., or based on a next time that the remote UE(s) 1406 need to be or are expected to be active. Upon the start of the overlap period, the source relay UE 1404-S and the target relay UE 1404-T pause relay configuration updates (step 1510 and 1512). This may include the target relay UE 1404-T signalling this to the base station 1402 and the source relay UE 1404-S, in some embodiments. In another embodiment, the base station 1402 signals to the target relay UE 1404-T (and optionally the source relay UE 1404-S) that relay configuration updates are to be paused. In another embodiment, the configuration updates, such as firmware updates, earlier scheduled at the relay UEs (1404-S and 1404-T) are not executed until the handover is complete and, if they are ongoing, they are completed before the state information is sent.

The source relay UE 1404-S sends state information to the target relay UE 1404-T, where this state information includes state information for the remote UE 1406 or the group 1405 of remote UEs (or the subset thereof) being handed over (step 1514). The source relay UE 1404-S may send the state information to the target relay UE 1404-T directly, e.g., via a sidelink or indirectly, e.g., via the base station 1402. During this time, there is no downlink traffic from the target relay UE 1404-T to the remote UE(s) 1406 being handed over.

Once transfer of this state information is complete, an optional sanity check procedure is performed (step 1516). For example, the sanity check procedure may be a checksum procedure to check the validity of the transferred state information. Further details regarding optional aspects of this sanity check procedure are described below.

Once transfer of the state information is complete and optionally once the sanity check is performed and is successful, the target relay UE 1404-T sends a state transfer confirm indication to the source relay UE 1404-S (step 1518), which then returns a handover end indication to the target relay UE 1404-T (step 1520). The source relay UE 1404-S may then send a handover complete indication to the base station 1402 (step 1522). The base station 1402 then sends, to the source relay UE 1404-S, an instruction to remove the relay configuration (step 1524). This includes revoking the relay ID at the source relay UE 1404-S such that the target relay UE 1404-T is now the only relay UE using that relay ID. At this point, the source relay UE 1404-S is no longer configured as the relay UE for the relay UE(s) 1406 (or group 1405) handed over. The source relay UE 1404-S and the target relay UE 1404-T resume relay configuration updates (step 1526 and 1528).

Note that, in some embodiments, when a remote UE 1406 wakes up, it may perform a sanity-check by determining whether the paired relay UE (i.e., the target relay UE 1404-T after handover) responds to its requests. In some other embodiments, the remote UE 1406 can skip this sanity-check procedure and directly initiate communication with the relay UE whose relay ID was recorded or programmed into it before entering the deep sleep, which after the completion of the handover is the target relay UE 1404-T. These form a part of the finalization step.

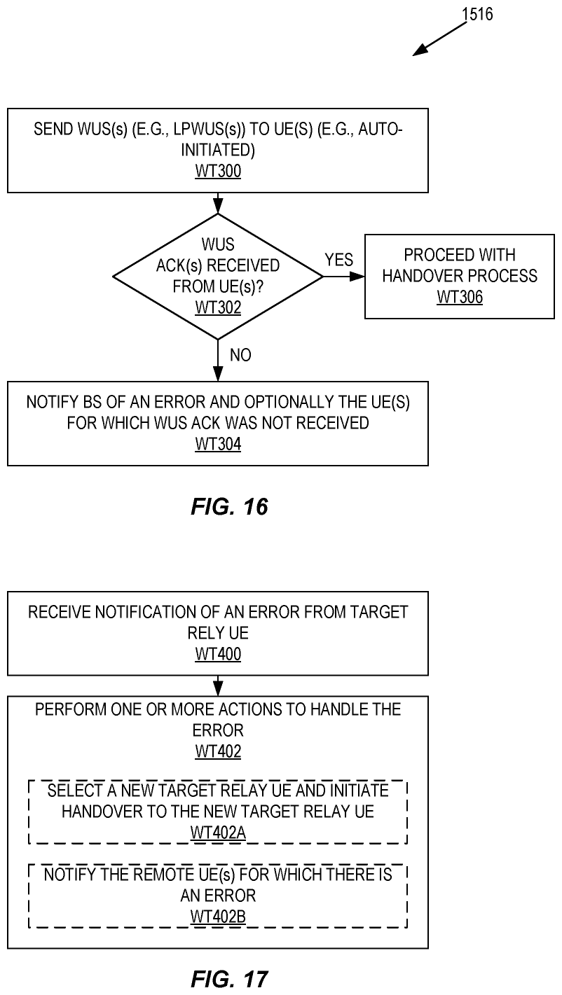

FIG. 16 is a flow chart that illustrates the operation of the target relay UE 1404-T to perform at least one aspect of the sanity check procedure of step 1516 of FIG. 15B, in accordance with an embodiment of the present disclosure. Since the relay migration can happen while the remote UE(s) 1406 are in deep sleep, the target relay UE 1404-T can auto-initiate a WUS (e.g., a LPWUS) to the remote node(s) 1406 to do a sanity check (1600). The target relay UE 1404-T monitors for WUS ACK(s) from the remote UE(s) 1406 (step 1602). If a WUS ACK(s) is(are) received from the remote UE(s) 1406 (step 1602, YES), the sanity check is successful and the handover procedure continues (step 1604). This may include sending a notification to the base station 1402 that it is able to serve as the relay UE for the remote UE(s) 1406. If a WUS ACK(s) is(are) not received from the remote UE(s) 1406 (step 1602, NO), the sanity check is not successful, and the target relay UE 1404-T notifies the base station 1402 that it is not able to function as the relay UE for the remote UE(s) 1406 (step 1606).

As illustrated in FIG. 17, upon receiving a notification from the target relay UE 1404-T that it is not able to function as the relay UE for the remote UE(s) 1406 (step 1700), the base station 1402 perform one or more actions to handle this error (step 1702). The one or more actions may include actions such as, e.g., selecting a new target relay UE and initiating handover to the new target relay UE (step 1702A). This new target relay UE is transferred the state information and relay ID in the same manner as described above. In case the base station 1402 cannot find another UE to act as a new target relay UE, in one embodiment, the base station 1402 directly notifies the remote UE(s) 1406 that is not assigned to any relay UE (step 1702B). The base station 1402 could additionally or alternatively proactively assign more than one target relay UE to start off with and then check which of these multiple target relay UEs can effectively cater to the remote UE(s) 1406.

Note that if the base station 1402 issues a WUS (e.g., a LPWUS) to the remote UE(s) 1406 or the group 1405 of remote UEs 1406 during the time that the sanity check procedure of FIG. 16 is being performed by the target relay UE 1404-T, then, in one embodiment, the target relay UE 1404-T transitions out of the sanity check state and instead uses the wake up ACKs from the remote UE(s) 1406 to do to further processing such as proxy data transfer between the base station 1402 and the remote UE 1406 or group 1405 of remote UEs 1406.

Note that, during the sanity check procedure, the last used time synchronization method before the relay UE migration could be used by the target relay UE 1404-T during the sanity check. Upon successful wake up, other synchronization methods may be used, if suitable for IoT function, as will be appreciated by those of ordinary skill in the art. Those skilled in art can also make adaptations to the above as deemed suitable.

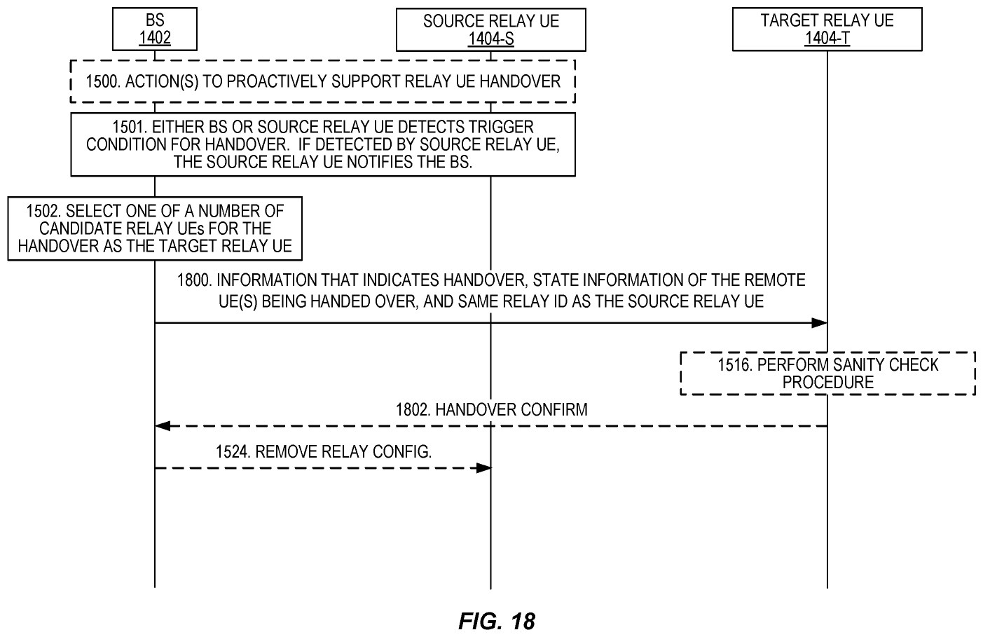

FIG. 18 illustrate the operation of the system 1400 for relay UE handover in accordance with another embodiment of the present disclosure. Optional steps are represented by dashed lines/boxes. Further, the “steps” illustrated in FIG. 18 are not necessarily performed in the illustrated order. These steps may be performed in any desired order unless otherwise indicated or required. The procedure of FIG. 18 is similar to that of FIGS. 15A and 15B and, as such, the same reference numbers as used in FIGS. 15A and 15B are used for steps that are the same as described above. As illustrated, one or more actions are performed to proactively support relay UE handover (step 1500). At some point, either the base station 1402 or the source relay UE 1404-S detects a triggering condition for handover of the remote UE 1406 or the group 1405 of remote UEs 1406 (or some subset thereof) (step 1501).

Once the triggering condition for relay UE handover is satisfied, the base station 1402 (or relay allocation application residing at the base station 1402 or another network node) selects the target relay UE 1404-T (step 1502). Once the target relay UE 1404-T is selected, the relay UE handover procedure is performed such that state information of the remote UE(s) being handed over, the group ID of the group 1405 if applicable, and the relay ID used by the source relay UE 1404-S are sent to the target relay UE 1404-T. In other words, the base station 1402 performs one or more actions to cause handover and migration of UE context information to the target relay UE 1404-T. More specifically, in the illustrated embodiment, the base station 1402 sends, to the target relay UE 1404-T: (a) information that indicates the handover of the remote UEs 1406 to the target relay UE 1404-T, (b) the state information for the remote UEs 1406 being handed over, and (c) information that configures the target relay UE 1404-T with the same relay ID as the source relay UE 1404-S (step 1800). Note that, in the case of multiple messages being sent in step 1800, it is beneficial to send the information that configures the target relay UE 1404-T with the same relay ID as the source relay UE 1404-S before sending the state information for the remote UEs 1406 being handed over. The information sent in step 1800 may be sent via a single message or via two or more messages.

Once transfer of the state information is complete, an optional sanity check procedure is performed, as described above (step 1516). For example, the sanity check procedure may be a checksum procedure to check the validity of the transferred state information. Further details regarding optional aspects of this sanity check procedure are described below.

Once transfer of the state information is complete and optionally once the sanity check is performed and is successful, the target relay UE 1404-T sends handover confirmation message to the base station 1402 that indicates that the handover and transfer of the state information is successful (step 1802). The base station 1402 then sends, to the source relay UE 1404-S, an instruction to remove the relay configuration (step 1524). This includes revoking the relay ID at the source relay UE 1404-S such that the target relay UE 1404-T is now the only relay UE using that relay ID. At this point, the source relay UE 1404-S is no longer configured as the relay UE for the relay UE(s) 1406 (or group 1405) handed over.

It is to be noted that, in some embodiments, the functions described herein as being carried out by a base station could alternatively be carried by a cluster head. A cluster head would be acting as a proxy for the base station in many functions such as resource management and therefore could take on roles that is carried out the base station described herein.

### IV. Further Details

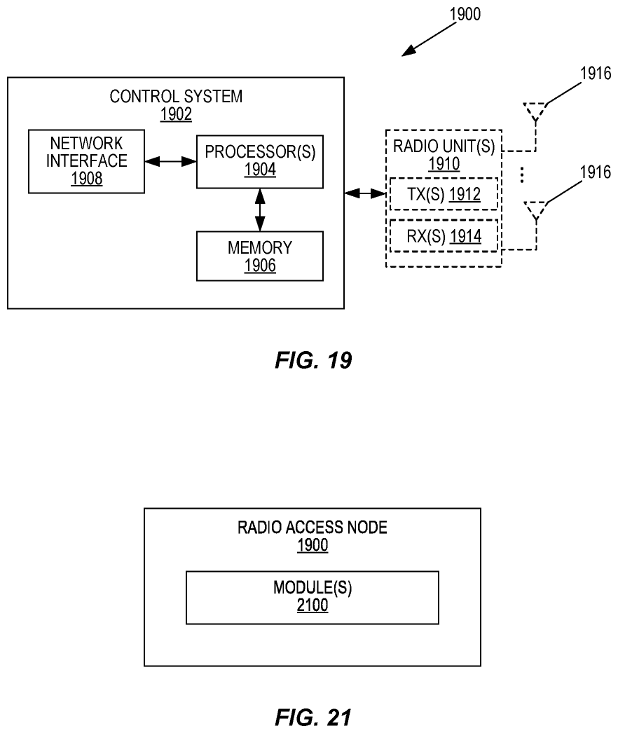

FIG. 19 is a schematic block diagram of a radio access node 1900 according to some embodiments of the present disclosure. Optional features are represented by dashed boxes. The radio access node 1900 may be, for example, the base station 102, 1102, or 1202 or a network node that implements all or part of the functionality of the base station 102, 1102, or 1202 described herein. As illustrated, the radio access node 1900 includes a control system 1902 that includes one or more processors 1904 (e.g., Central Processing Units (CPUs), Application Specific Integrated Circuits (ASICs), Field Programmable Gate Arrays (FPGAs), and/or the like), memory 1906, and a network interface 1908. The one or more processors 1904 are also referred to herein as processing circuitry. In addition, the radio access node 1900 may include one or more radio units 1910 that each includes one or more transmitters 1912 and one or more receivers 1914 coupled to one or more antennas 1916. The radio units 1910 may be referred to or be part of radio interface circuitry. In some embodiments, the radio unit(s) 1910 is external to the control system 1902 and connected to the control system 1902 via, e.g., a wired connection (e.g., an optical cable). However, in some other embodiments, the radio unit(s) 1910 and potentially the antenna(s) 1916 are integrated together with the control system 1902. The one or more processors 1904 operate to provide one or more functions of a radio access node 1900 as described herein (e.g., one or more functions of the base station 102, 1102, or 1202 as described herein). In some embodiments, the function(s) are implemented in software that is stored, e.g., in the memory 1906 and executed by the one or more processors 1904.

FIG. 20 is a schematic block diagram that illustrates a virtualized embodiment of the radio access node 1900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1900 in which at least a portion of the functionality of the radio access node 1900 is implemented as a virtual component(s) (e.g., via a virtual machine(s) executing on a physical processing node(s) in a network(s)). As illustrated, in this example, the radio access node 1900 may include the control system 1902 and/or the one or more radio units 1910, as described above. The control system 1902 may be connected to the radio unit(s) 1910 via, for example, an optical cable or the like. The radio access node 1900 includes one or more processing nodes 2000 coupled to or included as part of a network(s) 2002. If present, the control system 1902 or the radio unit(s) are connected to the processing node(s) 2000 via the network 2002. Each processing node 2000 includes one or more processors 2004 (e.g., CPUs, ASICs, FPGAs, and/or the like), memory 2006, and a network interface 2008.

In this example, functions 2010 of the radio access node 1900 described herein (e.g., functions of the base station 102, 1102, or 1202) are implemented at the one or more processing nodes 2000 or distributed across the one or more processing nodes 2000 and the control system 1902 and/or the radio unit(s) 1910 in any desired manner. In some particular embodiments, some or all of the functions 2010 of the radio access node 1900 described herein are implemented as virtual components executed by one or more virtual machines implemented in a virtual environment(s) hosted by the processing node(s) 2000. As will be appreciated by one of ordinary skill in the art, additional signaling or communication between the processing node(s) 2000 and the control system 1902 is used in order to carry out at least some of the desired functions 2010. Notably, in some embodiments, the control system 1902 may not be included, in which case the radio unit(s) 1910 communicate directly with the processing node(s) 2000 via an appropriate network interface(s).

In some embodiments, a computer program including instructions which, when executed by at least one processor, causes the at least one processor to carry out the functionality of radio access node 1900 or a node (e.g., a processing node 2000) implementing one or more of the functions 2010 of the radio access node 1900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 21 is a schematic block diagram of the radio access node 1900 according to some other embodiments of the present disclosure. The radio access node 1900 includes one or more modules 2100, each of which is implemented in software. The module(s) 2100 provide the functionality of the radio access node 1900 described herein. This discussion is equally applicable to the processing node 2000 of FIG. 20 where the modules 2100 may be implemented at one of the processing nodes 2000 or distributed across multiple processing nodes 2000 and/or distributed across the processing node(s) 2000 and the control system 1902.

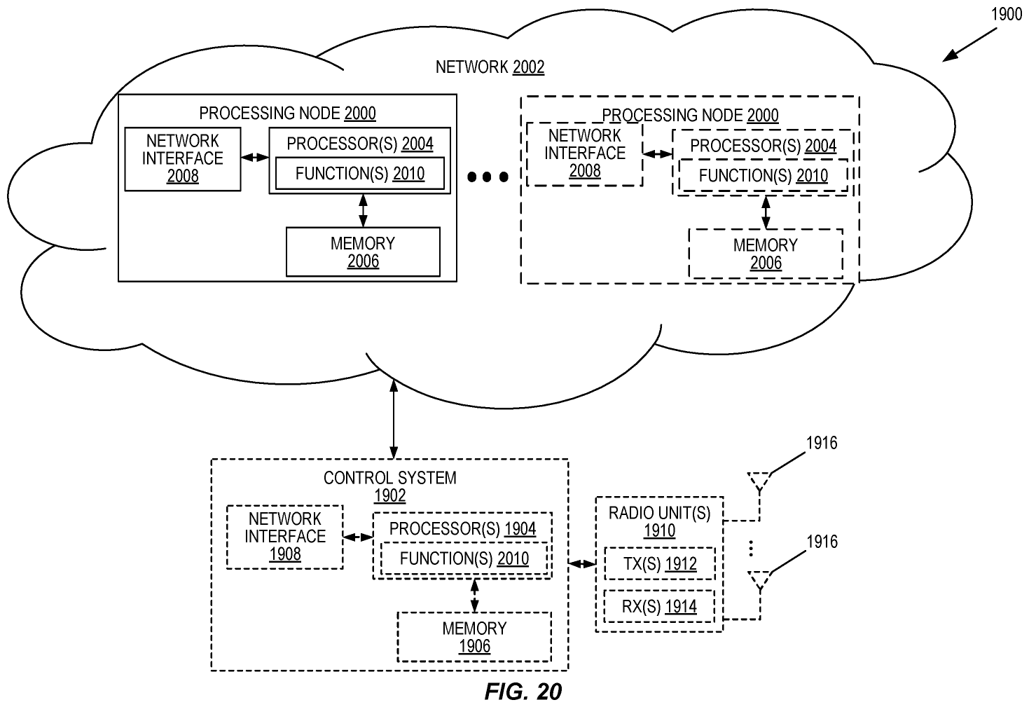

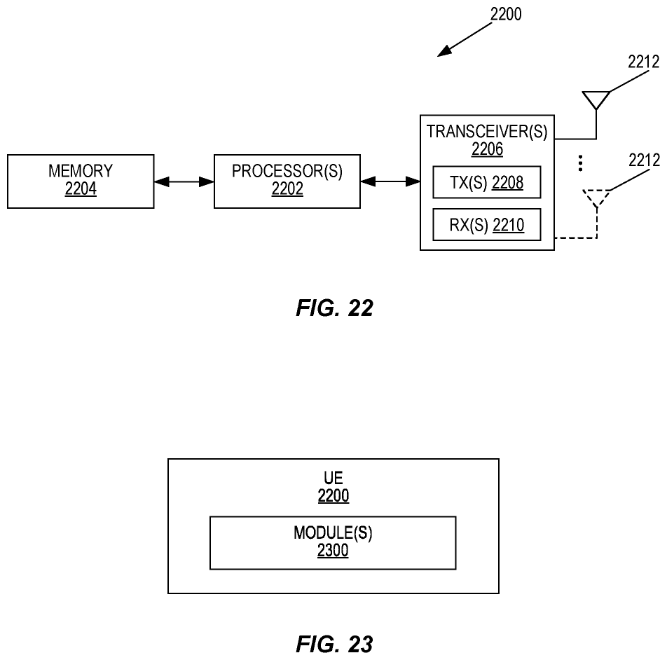

FIG. 22 is a schematic block diagram of a UE 2200 according to some embodiments of the present disclosure. The UE 2200 may be the relay UE 104, 604, 1104-1, 1104-2, 1204-1, or 1204-2 or the remote UE 106, 606, 1106-1, 1106-2, or 1206-3. As illustrated, the UE 2200 includes one or more processors 2202 (e.g., CPUs, ASICs, FPGAs, and/or the like), memory 2204, and one or more transceivers 2206 each including one or more transmitters 2208 and one or more receivers 2210 coupled to one or more antennas 2212. The transceiver(s) 2206 includes radio-front end circuitry connected to the antenna(s) 2212 that is configured to condition signals communicated between the antenna(s) 2212 and the processor(s) 2202, as will be appreciated by on of ordinary skill in the art. The processors 2202 are also referred to herein as processing circuitry. The transceivers 2206 are also referred to herein as radio circuitry. In some embodiments, the functionality of the UE 2200 described above (e.g., the functionality of the relay UE 104, 604, 1104-1, 1104-2, 1204-1, or 1204-2 or the remote UE 106, 606, 1106-1, 1106-2, or 1206-3 described above) may be fully or partially implemented in software that is, e.g., stored in the memory 2204 and executed by the processor(s) 2202. Note that the UE 2200 may include additional components not illustrated in FIG. 22 such as, e.g., one or more user interface components (e.g., an input/output interface including a display, buttons, a touch screen, a microphone, a speaker(s), and/or the like and/or any other components for allowing input of information into the UE 2200 and/or allowing output of information from the UE 2200), a power supply (e.g., a battery and associated power circuitry), etc.

In some embodiments, a computer program including instructions which, when executed by at least one processor, causes the at least one processor to carry out the functionality of the UE 2200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 23 is a schematic block diagram of the UE 2200 according to some other embodiments of the present disclosure. The UE 2200 includes one or more modules 2300, each of which is implemented in software. The module(s) 2300 provide the functionality of the UE 2200 described herein.

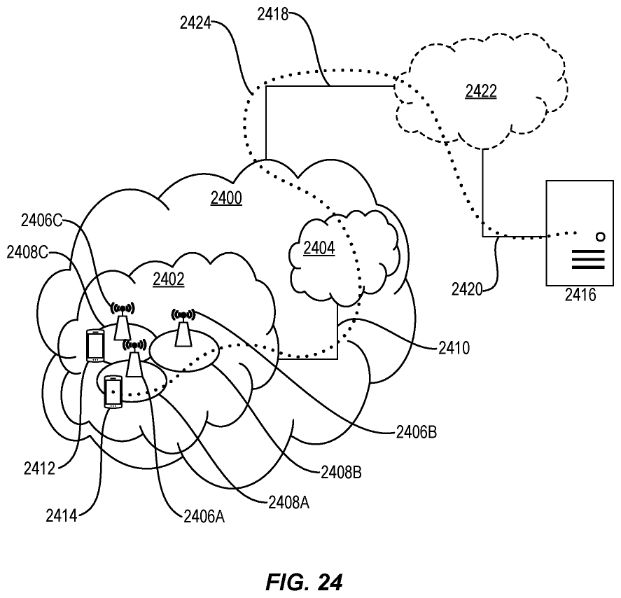

With reference to FIG. 24, in accordance with an embodiment, a communication system includes a telecommunication network 2400, such as a 3GPP-type cellular network, which comprises an access network 2402, such as a RAN, and a core network 2404. The access network 2402 comprises a plurality of base stations 2406A, 2406B, 2406C, such as Node Bs, eNBs, gNBs, or other types of wireless Access Points (APs), each defining a corresponding coverage area 2408A, 2408B, 2408C. Each base station 2406A, 2406B, 2406C is connectable to the core network 2404 over a wired or wireless connection 2410. A first UE 2412 located in coverage area 2408C is configured to wirelessly connect to, or be paged by, the corresponding base station 2406C. A second UE 2414 in coverage area 2408A is wirelessly connectable to the corresponding base station 2406A. While a plurality of UEs 2412, 2414 are illustrated in this example, the disclosed embodiments are equally applicable to a situation where a sole UE is in the coverage area or where a sole UE is connecting to the corresponding base station 2406.

The telecommunication network 2400 is itself connected to a host computer 2416, which may be embodied in the hardware and/or software of a standalone server, a cloud-implemented server, a distributed server, or as processing resources in a server farm. The host computer 2416 may be under the ownership or control of a service provider, or may be operated by the service provider or on behalf of the service provider. Connections 2418 and 2420 between the telecommunication network 2400 and the host computer 2416 may extend directly from the core network 2404 to the host computer 2416 or may go via an optional intermediate network 2422. The intermediate network 2422 may be one of, or a combination of more than one of, a public, private, or hosted network; the intermediate network 2422, if any, may be a backbone network or the Internet; in particular, the intermediate network 2422 may comprise two or more sub-networks (not shown).

The communication system of FIG. 24 as a whole enables connectivity between the connected UEs 2412, 2414 and the host computer 2416. The connectivity may be described as an Over-the-Top (OTT) connection 2424. The host computer 2416 and the connected UEs 2412, 2414 are configured to communicate data and/or signaling via the OTT connection 2424, using the access network 2402, the core network 2404, any intermediate network 2422, and possible further infrastructure (not shown) as intermediaries. The OTT connection 2424 may be transparent in the sense that the participating communication devices through which the OTT connection 2424 passes are unaware of routing of uplink and downlink communications. For example, the base station 2406 may not or need not be informed about the past routing of an incoming downlink communication with data originating from the host computer 2416 to be forwarded (e.g., handed over) to a connected UE 2412. Similarly, the base station 2406 need not be aware of the future routing of an outgoing uplink communication originating from the UE 2412 towards the host computer 2416.

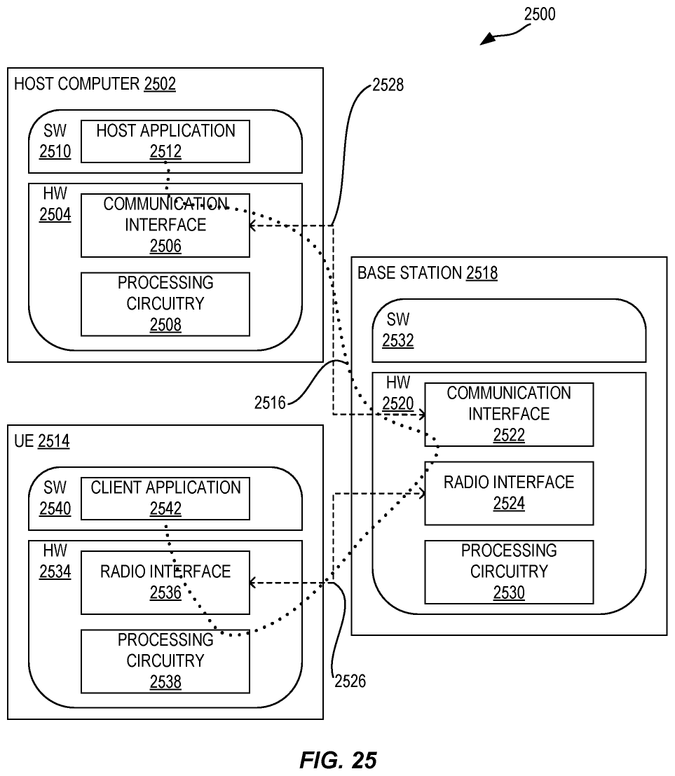

Example implementations, in accordance with an embodiment, of the UE, base station, and host computer discussed in the preceding paragraphs will now be described with reference to FIG. 25. In a communication system 2500, a host computer 2502 comprises hardware 2504 including a communication interface 2506 configured to set up and maintain a wired or wireless connection with an interface of a different communication device of the communication system 2500. The host computer 2502 further comprises processing circuitry 2508, which may have storage and/or processing capabilities. In particular, the processing circuitry 2508 may comprise one or more programmable processors, ASICs, FPGAs, or combinations of these (not shown) adapted to execute instructions. The host computer 2502 further comprises software 2510, which is stored in or accessible by the host computer 2502 and executable by the processing circuitry 2508. The software 2510 includes a host application 2512. The host application 2512 may be operable to provide a service to a remote user, such as a UE 2514 connecting via an OTT connection 2516 terminating at the UE 2514 and the host computer 2502. In providing the service to the remote user, the host application 2512 may provide user data which is transmitted using the OTT connection 2516.

The communication system 2500 further includes a base station 2518 provided in a telecommunication system and comprising hardware 2520 enabling it to communicate with the host computer 2502 and with the UE 2514. The hardware 2520 may include a communication interface 2522 for setting up and maintaining a wired or wireless connection with an interface of a different communication device of the communication system 2500, as well as a radio interface 2524 for setting up and maintaining at least a wireless connection 2526 with the UE 2514 located in a coverage area (not shown in FIG. 25) served by the base station 2518. The communication interface 2522 may be configured to facilitate a connection 2528 to the host computer 2502. The connection 2528 may be direct or it may pass through a core network (not shown in FIG. 25) of the telecommunication system and/or through one or more intermediate networks outside the telecommunication system. In the embodiment shown, the hardware 2520 of the base station 2518 further includes processing circuitry 2530, which may comprise one or more programmable processors, ASICs, FPGAs, or combinations of these (not shown) adapted to execute instructions. The base station 2518 further has software 2532 stored internally or accessible via an external connection.

The communication system 2500 further includes the UE 2514 already referred to. The UE's 2514 hardware 2534 may include a radio interface 2536 configured to set up and maintain a wireless connection 2526 with a base station serving a coverage area in which the UE 2514 is currently located. The hardware 2534 of the UE 2514 further includes processing circuitry 2538, which may comprise one or more programmable processors, ASICs, FPGAs, or combinations of these (not shown) adapted to execute instructions. The UE 2514 further comprises software 2540, which is stored in or accessible by the UE 2514 and executable by the processing circuitry 2538. The software 2540 includes a client application 2542. The client application 2542 may be operable to provide a service to a human or non-human user via the UE 2514, with the support of the host computer 2502. In the host computer 2502, the executing host application 2512 may communicate with the executing client application 2542 via the OTT connection 2516 terminating at the UE 2514 and the host computer 2502. In providing the service to the user, the client application 2542 may receive request data from the host application 2512 and provide user data in response to the request data. The OTT connection 2516 may transfer both the request data and the user data. The client application 2542 may interact with the user to generate the user data that it provides.

It is noted that the host computer 2502, the base station 2518, and the UE 2514 illustrated in FIG. 25 may be similar or identical to the host computer 2416, one of the base stations 2406A, 2406B, 2406C, and one of the UEs 2412, 2414 of FIG. 24, respectively. This is to say, the inner workings of these entities may be as shown in FIG. 25 and independently, the surrounding network topology may be that of FIG. 24.

In FIG. 25, the OTT connection 2516 has been drawn abstractly to illustrate the communication between the host computer 2502 and the UE 2514 via the base station 2518 without explicit reference to any intermediary devices and the precise routing of messages via these devices. The network infrastructure may determine the routing, which may be configured to hide from the UE 2514 or from the service provider operating the host computer 2502, or both. While the OTT connection 2516 is active, the network infrastructure may further take decisions by which it dynamically changes the routing (e.g., on the basis of load balancing consideration or reconfiguration of the network).

The wireless connection 2526 between the UE 2514 and the base station 2518 is in accordance with the teachings of the embodiments described throughout this disclosure. One or more of the various embodiments improve the performance of OTT services provided to the UE 2514 using the OTT connection 2516, in which the wireless connection 2526 forms the last segment.

A measurement procedure may be provided for the purpose of monitoring data rate, latency, and other factors on which the one or more embodiments improve. There may further be an optional network functionality for reconfiguring the OTT connection 2516 between the host computer 2502 and the UE 2514, in response to variations in the measurement results. The measurement procedure and/or the network functionality for reconfiguring the OTT connection 2516 may be implemented in the software 2510 and the hardware 2504 of the host computer 2502 or in the software 2540 and the hardware 2534 of the UE 2514, or both. In some embodiments, sensors (not shown) may be deployed in or in association with communication devices through which the OTT connection 2516 passes; the sensors may participate in the measurement procedure by supplying values of the monitored quantities exemplified above, or supplying values of other physical quantities from which the software 2510, 2540 may compute or estimate the monitored quantities. The reconfiguring of the OTT connection 2516 may include message format, retransmission settings, preferred routing, etc.; the reconfiguring need not affect the base station 2518, and it may be unknown or imperceptible to the base station 2518. Such procedures and functionalities may be known and practiced in the art. In certain embodiments, measurements may involve proprietary UE signaling facilitating the host computer's 2502 measurements of throughput, propagation times, latency, and the like. The measurements may be implemented in that the software 2510 and 2540 causes messages to be transmitted, in particular empty or ‘dummy’ messages, using the OTT connection 2516 while it monitors propagation times, errors, etc.

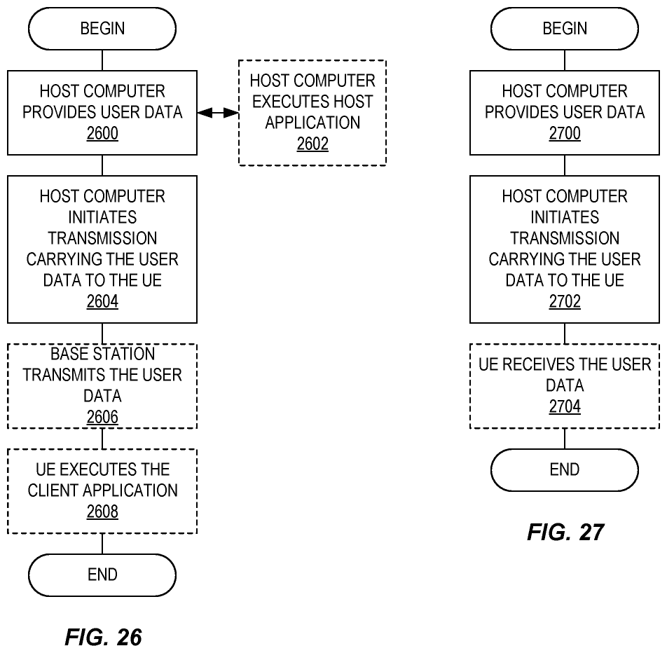

FIG. 26 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 26 will be included in this section. In step 2600, the host computer provides user data. In sub-step 2602 (which may be optional) of step 2600, the host computer provides the user data by executing a host application. In step 2604, the host computer initiates a transmission carrying the user data to the UE. In step 2606 (which may be optional), the base station transmits to the UE the user data which was carried in the transmission that the host computer initiated, in accordance with the teachings of the embodiments described throughout this disclosure. In step 2608 (which may also be optional), the UE executes a client application associated with the host application executed by the host computer.

FIG. 27 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 27 will be included in this section. In step 2700 of the method, the host computer provides user data. In an optional sub-step (not shown) the host computer provides the user data by executing a host application. In step 2702, the host computer initiates a transmission carrying the user data to the UE. The transmission may pass via the base station, in accordance with the teachings of the embodiments described throughout this disclosure. In step 2704 (which may be optional), the UE receives the user data carried in the transmission.

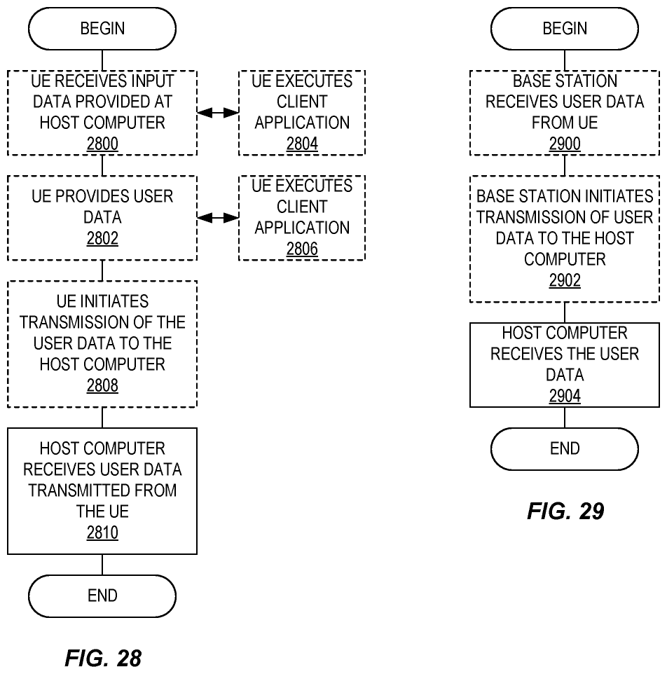

FIG. 28 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 28 will be included in this section. In step 2800 (which may be optional), the UE receives input data provided by the host computer. Additionally or alternatively, in step 2802, the UE provides user data. In sub-step 2804 (which may be optional) of step 2800, the UE provides the user data by executing a client application. In sub-step 2806 (which may be optional) of step 2802, the UE executes a client application which provides the user data in reaction to the received input data provided by the host computer. In providing the user data, the executed client application may further consider user input received from the user. Regardless of the specific manner in which the user data was provided, the UE initiates, in sub-step 2808 (which may be optional), transmission of the user data to the host computer. In step 2810 of the method, the host computer receives the user data transmitted from the UE, in accordance with the teachings of the embodiments described throughout this disclosure.

FIG. 29 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 29 will be included in this section. In step 2900 (which may be optional), in accordance with the teachings of the embodiments described throughout this disclosure, the base station receives user data from the UE. In step 2902 (which may be optional), the base station initiates transmission of the received user data to the host computer. In step 2904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method of operation of a network node for handover of one or more remote User Equipments, UEs, from a source relay UE to a target relay UE, the method comprising:
determining that a triggering condition for handover of one or more remote UEs from a source relay UE to a target relay UE has occurred; and
responsive to determining that the triggering condition has occurred:
selecting one of a number of candidate target relay UEs as the target relay UE for the handover; and
causing handover and migration of state information to the target relay UE, the state information comprising state information of the one or more remote UEs.

2. The method of claim 1 wherein the one or more remote UEs are in idle state.

3. The method of claim 1 wherein the target relay UE is assigned a same relay identity, ID, as the source relay UE.

4. The method of claim 1 wherein causing handover and migration of state information to the target relay UE comprises:
sending, to the source relay UE, an indication to start handover and migration of state information to the target relay UE, the state information comprising state information of the one or more remote UEs.

5. The method of claim 4 further comprising sending a relay identity, ID, to the target relay UE, wherein the relay ID sent to the target relay UE is the same as a relay ID of the source relay UE.

6. The method of claim 1 wherein causing handover and migration of state information to the target relay UE comprises:
sending, to the target relay UE, information that indicates handover of the one or more remote UEs to the target relay UE and the state information of the one or more remote UEs.

7-8. (canceled)

9. The method of claim 1 wherein the triggering condition for handover of the one or more remote UEs from the source relay UE to the target relay UE comprises:
the source relay UE becoming unresponsive;
the source relay UE being unresponsive for a predefined amount of time;
loss of connection between the source relay UE and at least one of the one or more remote UEs;
loss of connection between the source relay UE and the one or more remote UEs; or
a change in one or more conditions at the source relay UE that are related to operation of the source relay UE as a relay UE.

10. The method of claim 9 wherein the one or more conditions at the source relay UE comprise location of the source relay UE, mobility of the source relay UE, battery status of the source relay UE, change in workload of the source relay UE, change in battery supply of the source relay UE, or any combination thereof.

11. The method of claim 1 further comprising:
receiving, from the target relay UE, a notification that an error has occurred during the handover; and
performing one or more actions to handle the error.

12. The method of claim 11 wherein the error is a failure to setup connection one at least one of the one or more remote UEs.

13. The method of claim 11 wherein performing the one or more actions comprises:
selecting a new target relay UE for at least one first remote UE from among the one or more remote UEs; and
initiating handover of the at least one first remote UE to the new target relay UE.

14. The method of claim 13 wherein the at least one first remote UE is identified in the notification received from the target relay UE.

15. (canceled)

16. The method of claim 1 wherein the network node is either a base station or a cluster head that operates as a proxy for a base station.

17-19. (canceled)

20. A network node for handover of one or more remote User Equipments, UEs, from a source relay UE to a target relay UE, the network node comprising processing circuitry configured to cause the network node to:
determine that a triggering condition for handover of one or more remote UEs from a source relay UE to a target relay UE has occurred; and
responsive to determining that the triggering condition has occurred:
select one of a number of candidate target relay UEs as the target relay UE for the handover; and
cause handover and migration of state information to the target relay UE, the state information comprising state information of the one or more remote UEs.

21. (canceled)

22. A method of operation of a source relay User Equipment, UE, for handover of one or more remote UEs from the source relay UE to a target relay UE, the method comprising:
receiving, from a network node, an indication to start handover of one or more remote UEs from the source relay UE to a target relay UE and migration of state information to the target relay UE, the state information comprising state information of the one or more remote UEs;
responsive to receiving the indication to start handover and migration of the state information, transferring the state information to the target relay UE.

23. The method of claim 22 wherein the one or more remote UEs are in idle state.

24. The method of claim 22 wherein the target relay UE is assigned a same relay identity, ID, as the source relay UE.

25-35. (canceled)

36. A method of operation of a target relay User Equipment, UE, for handover of one or more remote UEs from a source relay UE to the target relay UE, the method comprising:
receiving a relay identity, ID, in association with a handover of one or more remote UEs, the handover being from a source relay UE to the target relay UE and the relay ID being the same as a relay ID of the source relay UE;
receiving state information in association with the handover of the one or more remote UEs from the source relay UE to the target relay UE, the state information comprising state information for the one or more remote UEs.

37. The method of claim 36 wherein the one or more remote UEs are in idle state.

38-40. (canceled)

41. The method of claim 36 further comprising performing a procedure to check whether handover was successful, wherein performing the procedure to check whether handover was successful comprises:
sending wake-up signals to the one or more remote UEs;
determining whether wake-up signal acknowledgments are received from the one or more remote UEs responsive to sending the wake-up signals;
completing the handover if wake-up signal acknowledgments are received from the one or more remote UEs; and
sending a notification of an error to a network node if a wake-up signal acknowledgments is not received from at least one of the one or more remote UEs.

42-46. (canceled)
